(19) United States
(12) Patent Application Publication
(10) Pub. No.: US 2015/0058133 A1
(43) Pub. Date: Feb. 26, 2015

(54) PERSONAL PROFILE RECEIVING APPARATUS AND METHOD OF USE THEREOF

(71) Applicants: Michael D. Roth, Scottsdale, AZ (US); Chris Diaz, III, Tempe, AZ (US)

(72) Inventors: Michael D. Roth, Scottsdale, AZ (US); Chris Diaz, III, Tempe, AZ (US)

(21) Appl. No.: 14/010,424

(22) Filed: Aug. 26, 2013

(51) Int. Cl. G06Q 30/02; G06F 17/30; H04L 29/08

(52) U.S. Cl. CPC G06Q 30/0269; H04L 67/306; G06F 17/30864
USPC 705/14.66; 340/539.11

(57) ABSTRACT

The invention comprises a profile system and/or a profile matching system. In the profile matching system, a profile of an individual is received by an external system, such as a company. The received profiled is matched with any of: (1) a second individual, (2) a group, (3) a piece of property, (4) a cluster of property, (5) an event, and (6) a company. A determined match is communicated back to the individual, such as directly to a device worn by the individual and/or indirectly, such as through a phone or tablet of the individual.

### TECHNICAL FIELD OF THE INVENTION

The present invention relates to a personal profile system.

### DESCRIPTION OF THE RELATED ART

Despite firms spending billions of dollars over decades researching and marketing to clients, individuals are still not properly matched to goods, services, events, businesses, and/or other individuals.

### Problem Statement

What is needed is a readily implemented and effective method of linking an individual with a business, an event, a location, a good, a service, and/or another individual.

### SUMMARY OF THE INVENTION

The invention comprises a first profile matching/tracking system optionally using a combination of an identification system, a personal profile system, and/or an interface to an outside system, such as to an individual, person, product, good, event, and/or business, such as through a second profile.

### BRIEF DESCRIPTION OF THE DRAWINGS

A more complete understanding of the present invention is derived by referring to the detailed description and claims when considered in connection with the Figures, wherein like reference numbers refer to similar items throughout the Figures.

FIG. 1 illustrates a profile matching system;

FIG. 2 illustrates a data to information pre-profiling system;

FIG. 3 illustrates a personal profile generation system;

FIGS. 4A and 4B illustrate a property classification system and an example thereof, respectively;

FIG. 5 illustrates an event classification system;

FIG. 6 illustrates an individual/property/event/location/company matching system;

FIG. 7 illustrates linking of profile systems;

FIG. 8A and FIG. 8B illustrate stored information and encrypted information, respectively;

FIG. 9 illustrates a profile based individual/company interaction;

FIG. 10A and FIG. 10B illustrate a combination lock parameter system and an example combination lock system, respectively;

FIG. 11 illustrates matching parameters to external systems;

FIG. 12 illustrates a first combination lock profile representation of an individual;

FIG. 13 illustrates a second combination lock profile representation of an individual;

FIG. 14 illustrates a personal identification system;

FIG. 15 illustrates a smart phone;

FIG. 16 illustrates a bracelet;

FIG. 17 illustrates a matching system;

FIG. 18 illustrates matching in n-dimensional space;

FIG. 19 represents use of a matching system to form microsites;

FIG. 20 illustrates a microsite updated with time to personal preferences;

FIG. 21A and FIG. 21B illustrates linked businesses and an example thereof, respectively;

FIG. 22 illustrates a business rewards system;

FIG. 23 illustrates a linked business reward system;

FIG. 24 illustrates a personal medical sensor; and

FIG. 25 illustrates a personalized world wide web system.

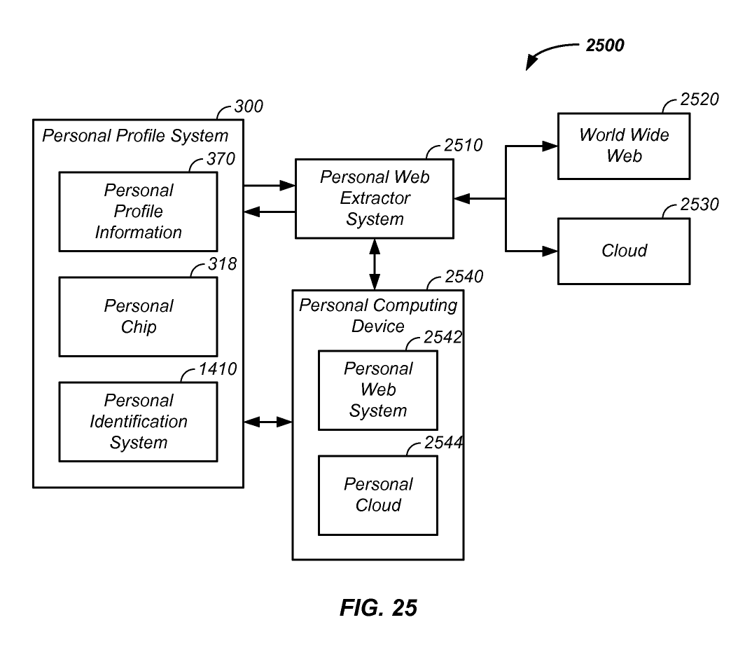

Elements and steps in the figures are illustrated for simplicity and clarity and have not necessarily been rendered according to any particular sequence. For example, steps that are performed concurrently or in different order are illustrated in the figures to help improve understanding of embodiments of the present invention.

### DETAILED DESCRIPTION OF THE PREFERRED EMBODIMENTS

The invention comprises a profile system.

In another embodiment, the invention comprises a profile matching system.

Several initial examples are used, without limitation, to further describe the profile system and/or the profile matching system. In a first example, the profile system uses profiles match an individual with a business offering one of more of a piece of property, an event, a good, a service, a second individual, a group, and/or a business. Based upon information broadcast from the individual, the business generates a match with a good and/or a service provided by the business and communicates the match to the individual, such as through a individualcast.

In yet another embodiment, the invention comprises a tracking system.

In still another embodiment, the tracking system comprises a personal tracking system, property tracking system, and/or an event tracking system.

In still yet another embodiment, rewards are linked to actions of a person identified with a personal identification system and/or personal chip.

In yet still another embodiment, personalized advertisements are served to an individual based upon preferences maintained in a personal identification system and/or a personal chip.

In yet still another embodiment, the tracking system brings together an individual with goods and/or events that correlate with the individual's personal preferences.

In still yet another embodiment, the personal tracking system using an individual's preferences operates in conjunction with a series of linked businesses and/or a conglomerate to provide a series of rewards for a chain of events, services, and/or property exchanges, where the series of rewards are provided to the individual and/or are distributed amongst the series of linked businesses.

In still yet another embodiment, the personal profile system contains valuable and/or private information about the associated individual. As such, security of the information is optionally and preferably protected. The protected information that is encrypted or encoded allows the individual to interact with one or more companies in a manner mutually beneficial to the individual and a company. For instance, the individual enters volunteered data into a personal computing device that they are seeking a particular gismo. The volunteered or personal data is classified by the classifier into personal profile information of a personal profile system and is matched using a matching system to a gizmo product or service of one of the linked companies. The location of the gizmo for sale is provided by an analyzer via an individualcast and/or a personalized microsite served to the individual. The linking system thereby benefits the individual and the company. Notably, the company/profile matching system additionally applies to property, goods, and services.

### Company/Profile Matching

In one embodiment, one or more profiles are linked to one or more companies in a mutually beneficial manner. For clarity of presentation, several examples are initially provided followed by additional examples/embodiments of the underlying components.

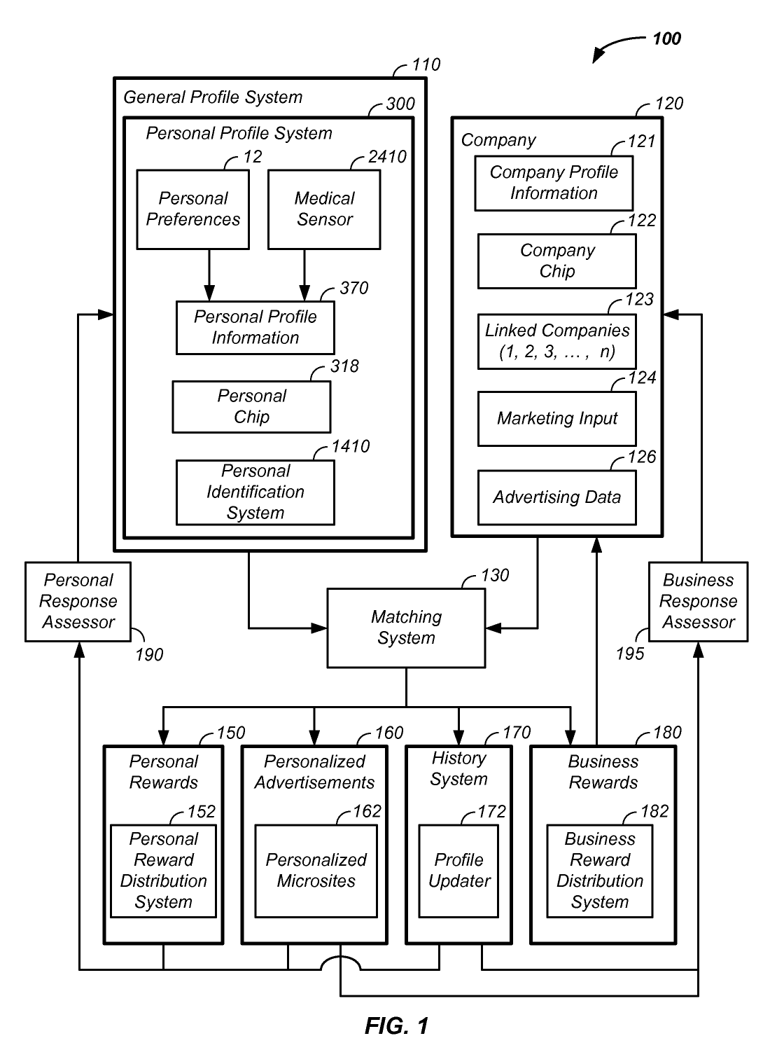

Referring now to FIG. 1, an example of a company/profile matching system 100 is illustrated. Generally, a general profile system 110 is linked to a company 120 using a matching system 130, such as an intelligent matching system. The general profile 110 is optionally to: (1) an individual 30, a person, or a group, (2) a product or group of products, (3) an event or group of events, and/or (4) a company or business. The company 120 is optionally a single company, a conglomerate, or a group of linked businesses.

Still referring to FIG. 1, without loss of generality, an example of a personal profile system 300 linked to a company is used to illustrate the cases of:
personal profile information linked to one or more of:
   an identification system;
   a location;
   property;
   a good;
   a service;
   an event, such as an activity, function, live performance, social gathering, tradeshow, and/or festival;
   a reward; and/or
   a medical sensor;
a piece of property and/or a good linked to one or more of:
   an identification system;
   a location;
   other goods;
   a service;
   an event; and/or
   a warranty; and/or
a service linked to one or more of:
   an agreement;
   a warranty; and/or
   a reward.

Generally, the personal profile system 300 linked to the company 120 is a non-limiting example of a profiled person, group, object, and/or event linked to a business, a reward system, a history, and/or to another person, group, object, and/or event.

Still referring to FIG. 1, the example of the personal profile system 300 linked to the company 120 is further described. The personal profile system 300 optionally includes: personal profile information 370, a personal chip 318, and/or a personal identification system 1410, each of which are further described infra. The personal profile system 300 provides to the matching system 130 information about the individual 30. The matching system 130 also receives information from the company 120 or information on any piece of property 40, good, service, marketer, or history. The matching system 130 matches a good, a service, a group, and/or a second person to the individual 30. Multiple cases further describing the company/profile matching system 100 are provided, infra.

In a first case, the company 120 is a series of linked companies 123. Several examples clarify the linked companies 123. In a first example, a first company provides a manufacturing material, a second company manufactures a product, a third company sells the product, a fourth company warranties the product, a fifth company provides repairs to the product, and a sixth company provides accessories for the product. Generally, n companies are linked, where n is a positive integer, such as two, three, four, or more companies.

In a second case, marketing input 124 and/or advertising data 126 are provided from and/or to the company 120 and/or the linked companies 123.

In a third case, the company/profile matching system 100 provides personal rewards 150 to the individual 30 using a personal reward distribution system 152. For example, the personal rewards 150 aggregate from two, three, four, or more of the linked companies 123. Optionally, rewards, such as cash rewards, points usable in another transaction in lieu of cash, and/or tangible physical gifts, are tracked, appended, cumulated, and/or stored using communication from the personal profile system 300, personal identification system 1410, and/or personal chip 318.

In a fourth case, the company/profile matching system 100 provides personalized advertisements 160 to the individual 30 based on: (1) personal preferences 12 of the individual 30, (2) the personal profile information 370 of the individual 30, and/or (3) results of the matching system 130. In one example, the personalized advertisements 160 take the form of one or more personalized microsites 162, micro-websites, and/or a temporary website, such as a website limited to a number of views or to a set elapsed time, where the personalized microsite 162 is tailored to the individual 30.

In a fifth case, the company/profile matching system 100 uses a personal history system 170 linked to the individual 30. For example, the personal history system 170 uses a profile updater 172 to update history of the individual 30 based on interactions of the individual 30 with outputs of the matching system 130, such as a short pause on a served microsite, a longer pause indicating interest on a served microsite, a click on a link from a served microsite, a purchase, and/or feedback from the individual 30.

In a sixth case, the company/profile matching system 100 links to business rewards 180 provided to the linked companies 123. The business rewards 180 function much like the personal rewards 150 but are distributed to the linked businesses 123 by a business reward distribution system 182. For examples, points, discounts, rewards, and/or money are distributed to the linked companies 123 based on interaction of the individual 30 with the information, products, and/or services provided to the matching system 130 from the respective companies of the linked businesses companies 123.

In a seventh case, the company/profile matching system 100 uses a personal response assessor 190 to update any element of the personal profile system 300 based on interaction of the individual 30 with any element output from the matching system 130, such as reaction of the individual 30 to the personalized advertisements 160.

In an eighth case, the company/profile matching system 100 uses a business response assessor 195 to provide feedback to the company 120 and/or the linked companies 123 based on interaction of the individual 30 with any element output from the matching system 130 to the individual 30, such as reaction of the individual 30 to the personalized advertisements 160 and/or a purchase of a good or service by the individual 30.

### Product

In a ninth case, the company/profile matching system 100 links profiles of a product, prior sale, purchase, or good with the company 120 and/or the linked companies 123 using the matching system 130.

### Service

In a tenth case, the company/profile matching system 100 links the individual 30 to an event and/or to a product, service, venue, or secondary event proximate the first event.

### Company

In an eleventh case, the company 120 has a stored profile, such as in computer readable memory and/or in a company chip 122.

In a twelfth case, the company 120 is linked by the matching system 130 to another business.

### Pre-Profiling/Classifying Systems

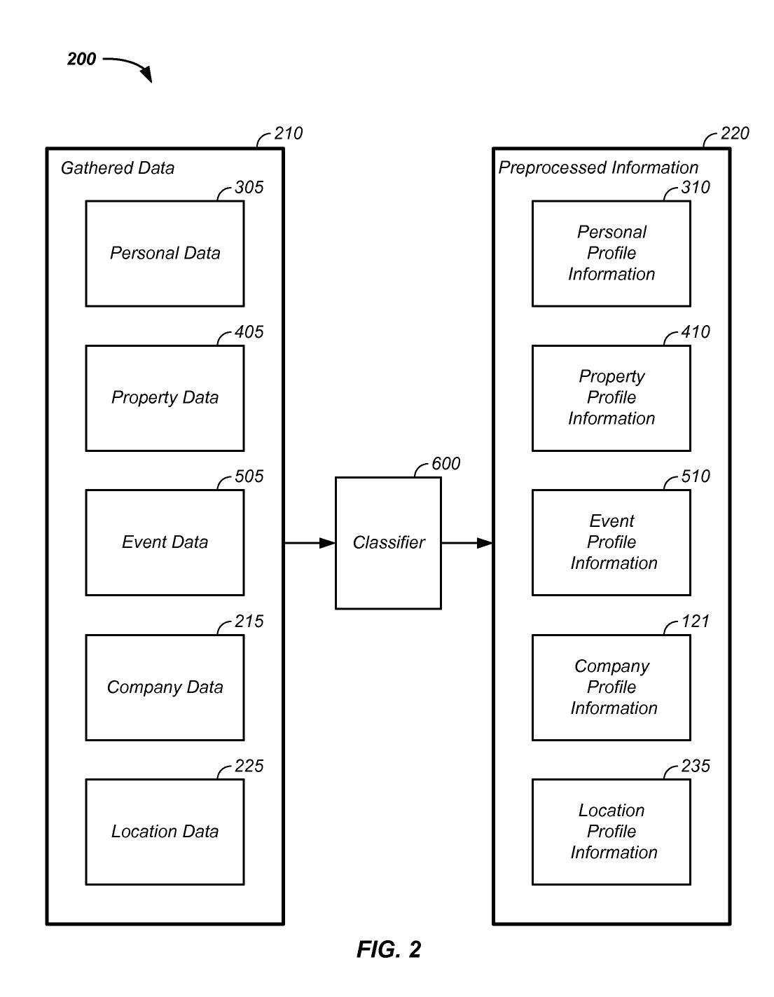

Referring now to FIGS. 2-5, the general profile system 110 is further described. Particularly, a pre-profiling system 200 is described, the personal profile system 300 is further described, a property classification system 400 is described, and an event classification system 500 is described. The described personal profile system 300 is optionally applied to an entity profile, such as a business, corporation, S-corporation, limited liability company, limited liability partnership, sole proprietorship, and/or group.

### Pre-Profiling System

Referring now to FIG. 2, the pre-profiling system 200 is further described. Generally, the pre-profiling system 200 uses a classifier 600 to analyze gathered data 210 and to generate pre-processed information 220. The gathered data 210 includes personal data 305, property data 405, event data 505, company data 215, and/or location data 225. The corresponding preprocessed information 220 includes personal profile information 310, property profile information 410, event profile information 510, company profile information 121, and/or location profile information 235.

### Personal Profile System

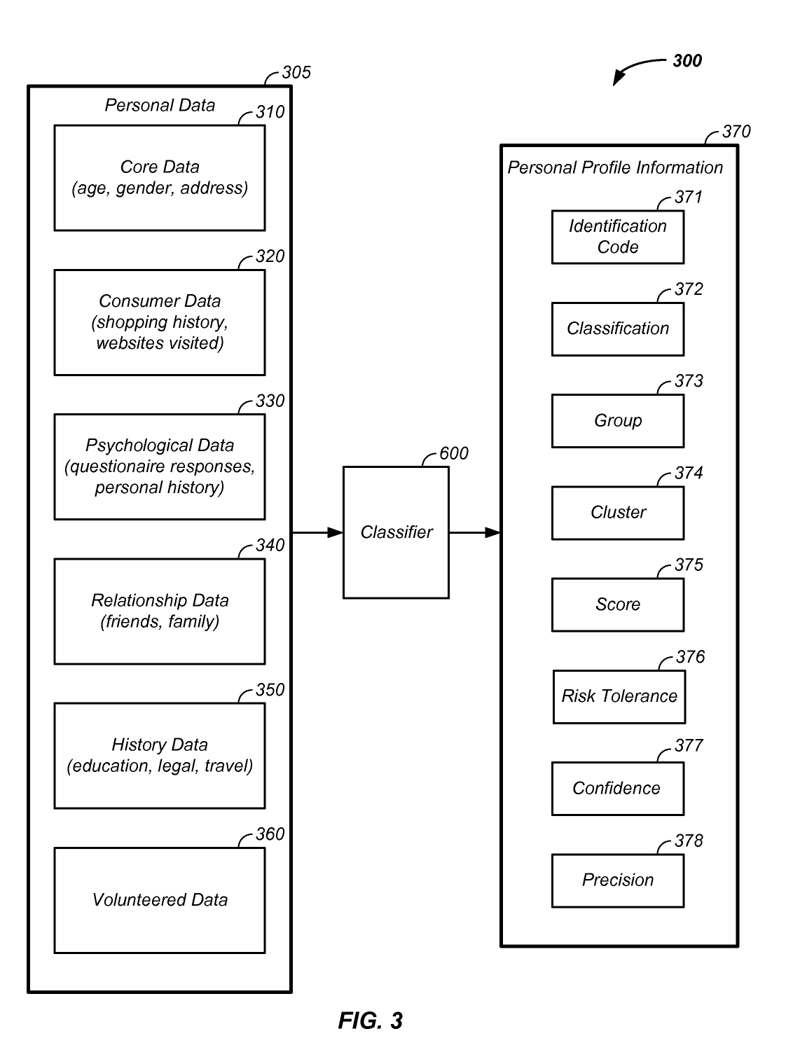

Referring now to FIG. 3, the personal profile system 300 is further described. Generally, the classifier 600 is used to analyze personal data 305 and to generated personal profile information 370 associated with the individual 30. Examples of personal data 305 include, but are not limited to: (1) core data 310, which is basic information associated with the individual 30, such as age, gender, and/or an address; (2) consumer data 320, which is information related to consumer habits and/or consumer history of the individual 30, such as shopping history, transaction history, and/or a website history; (3) psychological data 330, which relates to psychological profile information about the individual 30, such as generated through responses to one or more questionnaires and/or through an analysis of the history of the individual 30; (4) relationship data 340, which relates to interpersonal relationships of the individual 30, such as with a friend, a family, a membership, a group affiliation, and/or to an online linked associate; (5) history data 350, which relates the individual's past, such as education, legal record, travel history, prior associations, and/or history more than one, two, or three years old; and (6) volunteered data 360, which is any information provided by the individual 30, such as personal preferences, wishes, desires, and/or interests. The generated personal profile information 370 is any mathematical and/or symbolic representation of the individual 30 as an independent unit and/or as part of a larger group, such as an identification code 371, a classification 372, a group assignment 373, a cluster 374, a score 375, an assessed confidence or an assessed willingness to take risk or risk tolerance 377, an assessed accuracy, probability, or confidence 377 in the data, and/or precision 378 of any aspect of the personal profile information 370.

Still referring to FIG. 3, the mathematical and/or symbolic representation of the individual 30 is optionally an output of any mathematical model. The mathematical model optionally uses a-priori information, input from the individual 30, any element of the personal data 305, a probabilistic analysis, Bayesian statistics, a soft-model, a neural network, a hard-model, mathematical inference, statistical analysis, fuzzy logic, and/or an intelligent system in the assignment of any of the elements of the personal profile information 370. The personal profile information 370 is optionally encrypted, as described infra.

### Property Classification System

Referring again to FIG. 2, similar to the manner that the individual 30 is optionally linked to the individual's personal profile information 310, a piece of property 40 or a good is optionally linked to property profile information 410 or to good profile information. For example, a piece of property 40 has a property profile containing information, such as original manufacturer, retail outlets, price, warranty, repair center, date of manufacture, date of sale, bill of materials, part number(s), function, location, and/or interface to other objects. Herein, for clarity of presentation the term property also refers to a good.

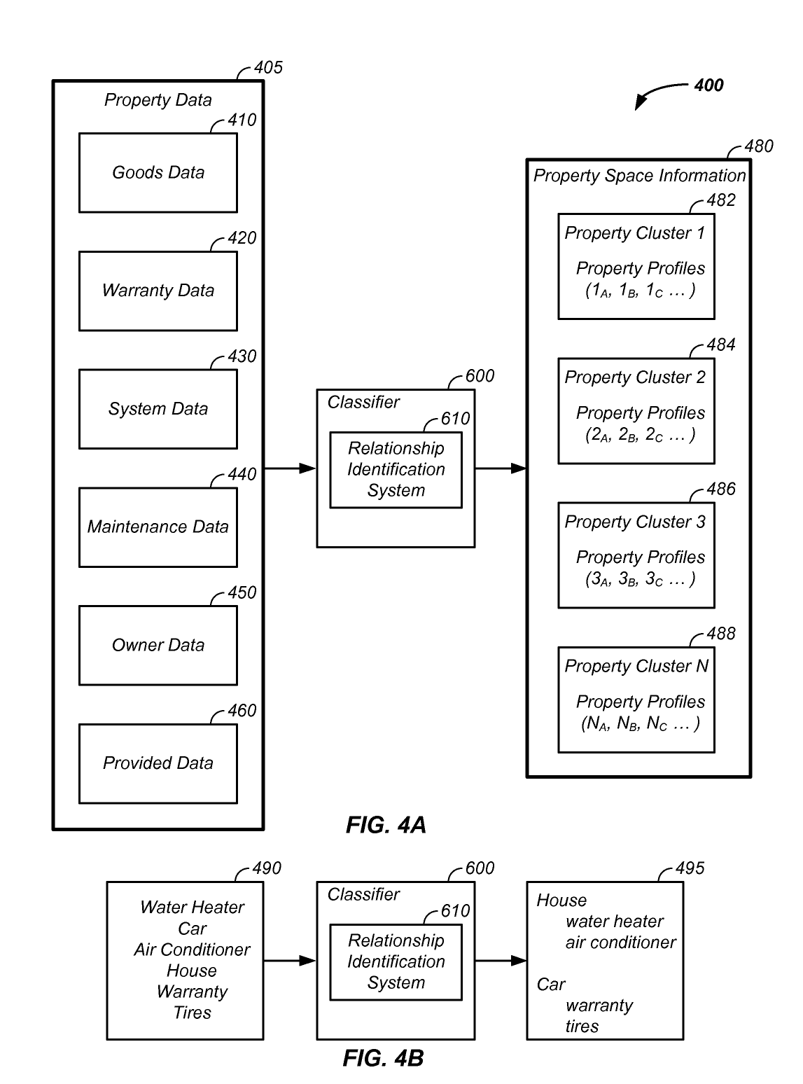

Referring now to FIG. 4A, similar to the manner that the classifier 600 is optionally used to generate personal profile information 300, the classifier 600 is optionally used as part of a property classification system 400.

Still referring to FIG. 4A, in the property classification system 400, property data 405 is converted into property space information 480 using the classifier 600. Examples of property data 405 include, but are not limited to: (1) goods data 410, which is basic information associated with the physical property; (2) warranty data 420 associated with the property or good; (3) system data 430, which relates to a larger part or system of which the goods are a part; (4) maintenance data 440, which is a record of past, current, and future maintenance; (5) owner data 450, which is a record of past and/or current owners; and (6) provided data 460, which is data relating to the property provided to the classifier 600.

Still referring to FIG. 4A, the classifier 600 optionally uses a relationship identification system 610 to establish and/or use relationships between two or more pieces of property. For example, the property space information 480 is optionally related in terms of property clusters, such as a first property cluster 482, a second property cluster 484, a third property cluster 486, and an N^{th} property cluster 488 where N is a positive integer. Optionally, a single element is present in more than one cluster. Optionally, two or more clusters overlap.

Referring now to FIG. 4B, for clarity of presentation and without limitation an example of two property clusters is provided. Property data 405, such as a first set of property data 490 is optionally classified using the relationship identification system 610 of the classifier 600 into related clusters of information 495, which are examples of property clusters. In this example, the property data is grouped into a house cluster and a car cluster. The clusters of information are subsequently used by the individual 30 and the linked company 120 in a mutually beneficial manner. In a first case, a first company optionally provides a warranty to all property 40 in the first house cluster while a second company optionally provides warranty and repair coverage for all objects in the second car cluster. In a second case, a series of linked companies 123 provide coverage for a series of clusters of property owned by the individual 30.

Referring now to FIG. 3A and FIG. 4, the inventor notes that the individual 30 is optionally linked to the property data 405 and the individual's personal profile information 370 is optionally linked to the property space information 480. Hence, the profile of each piece of property 40, good, and/or service is optionally linked to the individual 30, such as through the individual's personal profile information 370 and/or is linked through a remote database, such as in the cloud. Similarly, each piece of property 40, good, and/or service is optionally linked to the business 120, such as through the business profile information 121.

### Event Classification System

Referring again to FIG. 2, similar to the manner that the individual 30 is optionally linked to the individual's personal profile information 310, an event 50 is optionally linked to event information 52, such as an event microchip proximate an entrance to the event. For example, the event 50 has an event profile containing information, such as date, location, attendees, and neighboring events or venues.

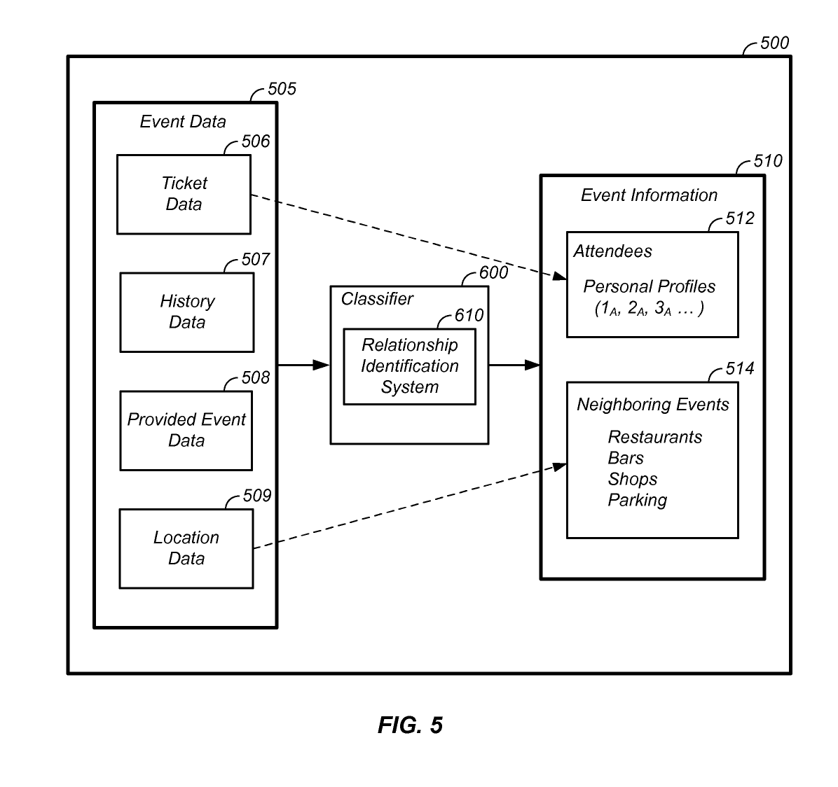

Referring now to FIG. 5, similar to the manner that the classifier 600 is optionally used to generate personal profile information 300, the classifier 600 is optionally used as part of an event classification system 500.

Still referring to FIG. 5, the event classification system 500 analyzes event data 505 to form event information 52, such as through use of the classifier 600 and/or through use of the relationship identification system 610. For example, the event data includes basic data, such as: (1) ticket data 506, which includes the number of tickets available and/or sold; (2) history data 507, which includes information about the event in the past; (3) provided event data 508, which is additional data provided, such as by the holder of the event; and/or (4) event location data 509. In stark contrast, the event information 52 contains broader, processed, mathematically represented, and/or more detailed information about the event in the context of a world view outside of the particular event, such as information on the attendees 512 or more particularly profile information on the attendees beyond the core data 310. Similarly, the event information 52 optionally includes information on a neighboring event 514, such as neighboring restaurants, shops, bars, parking, and the like.

The event information 52 is optionally combined with information on the individual 30 and/or is combined with information on the property 40 and/or goods, the company 120, and/or the location 70, such as through the property space information 480. In a first example, optionally personal profiles of ticket holders are examined to determine suitable advertising, such as to a local venue, for event paraphernalia, for advertising to similar events, to parking, and the like. In a second example, commonalities of attendees are determined to inform attendees of others with common interests, religious beliefs, culture, language, and/or to suggest meeting locations. For instance, during a pilgrimage thousands of individuals converge on a site or venue. The second example is further expanded on, infra.

### Location Classification System

Referring again to FIG. 2, similar to the manner that the individual 30 is optionally linked to the individual's personal profile information 310, a location 70 is optionally linked to location information 72. For example, a location 70 has a location profile containing information, such as history, contact information, facilities, hours. For example, a national monument location contains information about the national monument. Optionally, a national monument chip interacts with a personal chip to give information to the individual 30 based on the individual's personal profile information 370, such as directions to a mountain bike trail, a particular type of restaurant, and/or particular background information on the national monument related to the interests of the individual 30.

### Business Classification System

Referring again to FIG. 2, similar to the manner that the individual 30 is optionally linked to the individual's personal profile information 310, the company 120 is optionally linked to company profile information 121. For example, a company 120 has a property profile containing information, such as history, location, contact information, executives, divisions, produced goods, and/or provided services.

### Individual/Property/Event/Location/Company Connection

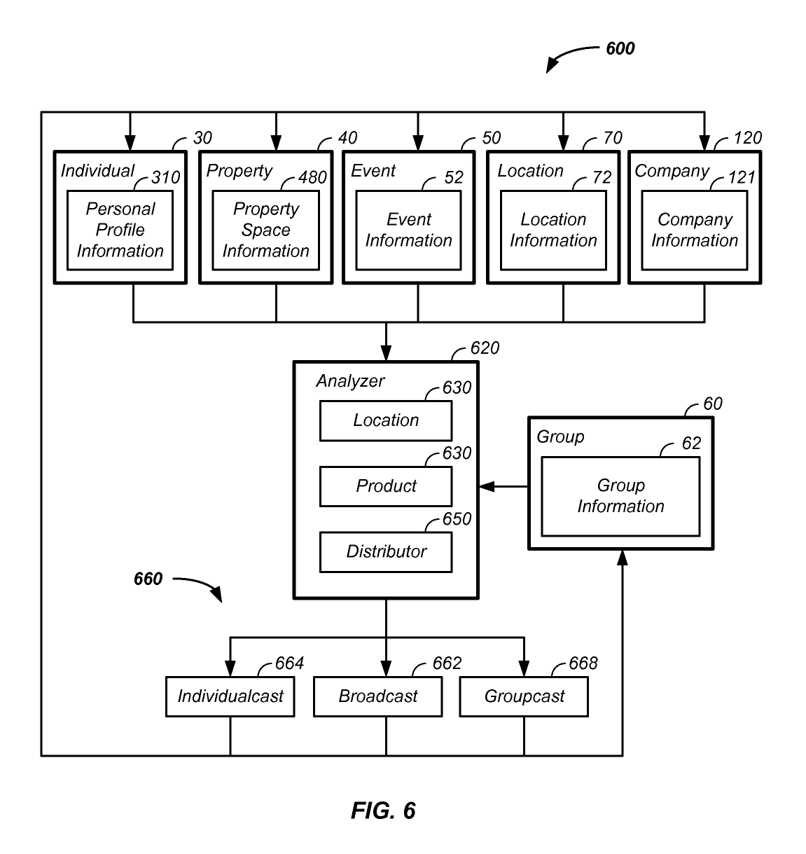

Referring now to FIG. 6, an analyzer 620 optionally uses output of the classifier 600, the personal profile information 310, the property space information 480, the event information 52, the location information 72, and/or the company information 121 to convey information about the individual 30, the property 40 or good, the event 50, a location 70, and/or a company 120 with each other or to other individual's, other pieces of property 40, other events, and/or other companies.

In a first example, the use of the personal profile information 310 of each individual 10 of a set of individuals along with the event information 52 allows a broadcast 662, a groupcast 668, and/or an individualcast 664 of specific information to the set of individuals, a subset of the set of individuals, and/or to the individual 10, respectively. Herein, the term broadcast refers to widely sending out information, such as through radio, television, and/or to a traditional webpage. In stark contrast, herein the term individualcast 664 refers to the transmission or sending of individualized information to the individual 30. The individualized information is optionally derived using the matching system 130 and/or the analyzer 620, which matches the personal profile information 370 with the company 120. For example, instead of a television commercial, such as an automobile advertisement, broadcast to all viewers or a traditional webpage set up on the web for all to find, the individualcast 664 sends the individualized information to the individual 30, such as in the form of an individualized webpage, such as a microsite, an individualized smart television commercial, such as to an internet protocol address, and/or to a smart radio, such as through the web. Optionally, the individualized webpage is available only to the individual 30. Optionally, the individualized webpage is deleted after viewing by the individual 30. Optionally, the individualized information is sent to any personal communication device used by the individual 30. Herein, the term groupcast 668 refers to sending information and/or an advertisement to a group of individual's based upon on commonality in their respective personal profiles.

In a second example, information about attendees at a particular event 40 is analyzed, such as with the analyzer 620 and information is sent, such as through a series of individualcasts 664, such as to suggested meeting locations to meet others of the same sect, belief, hometown, local dialect, and the like.

In a third example, the analyzer 620 uses a distributor 650 to send information about a place location 70 or product 630 to one or more individuals based upon commonalities determined from personal the profile information 310, the property space information 480, and/or the event information 52.

Still referring to FIG. 5 and FIG. 6, generally the results of the individual, goods, event, location, and/or company classifications allows the establishment and/or use of relationships between any combination of individuals, goods, events, locations, and/or companies, such as two or more events, between the event and the individual 30, between the event and a group of individuals, between the event and the individual's personal profile information 370, and/or between the event and the property space information 480.

### Profile Systems

The general profile system 110 is further described herein. More particularly, a personal profile system, a personal profile/marketing system, a personal identification system, and a personal medical system are described.

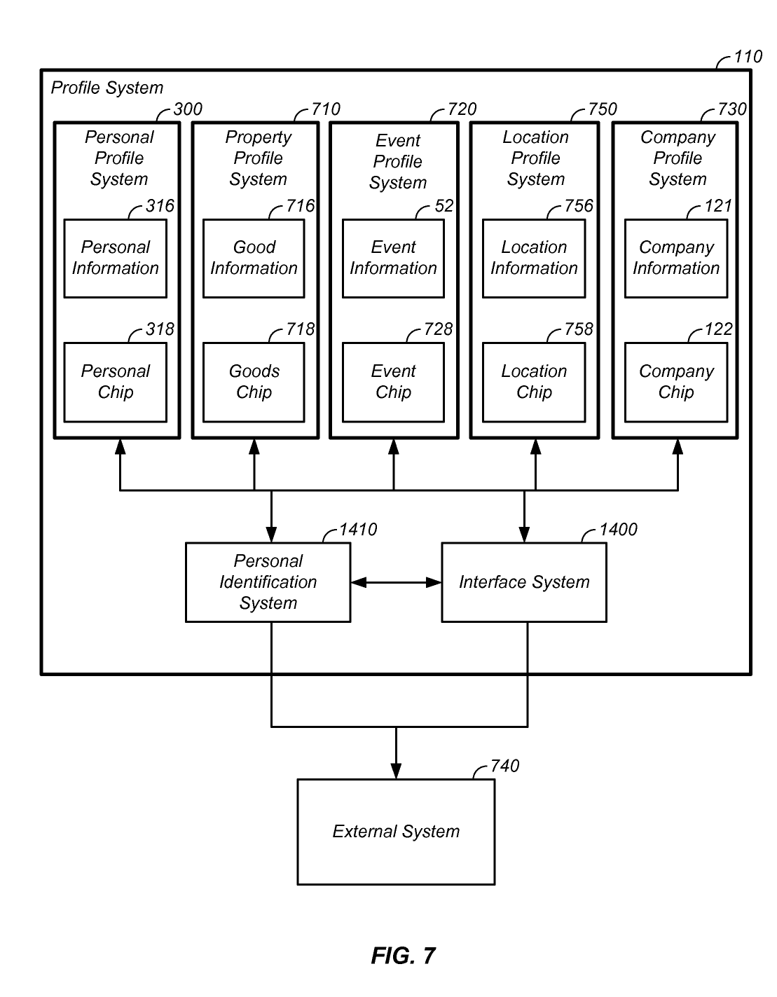

Referring now to FIG. 7, the general profile system 110 is further described. Heretofore and in FIG. 1, the personal profile system 300 was primarily used to describe the general profile system 110. Herein, it is again clarified that the personal profile system 300 of the general profile system 110 is representative of a property profile system 710, an event profile system 720, a location profile system 750, and/or a company profile system 730. Particularly, just as the personal profile system 300 contains personal information 316, the property profile system 710 contains goods information 716, the event profile system 720 contains event information 52, the location profile system 750 contains location information 756, and the company profile system 730 contains company information 121. Optionally, the personal profile system 300 stores the personal information 316 on a personal chip 318, the property profile system 710 contains the goods information 716 on a goods chip 718, the event profile system 720 contains the event information 52 on an event chip 728, the location profile system 750 contains the location information 756 on a location chip 758, and/or the company profile system 730 contains the company information 121 on the company chip 122. For clarity of presentation and without limitation, the personal chip 318 is herein further described and is representative of the goods chip 718, the event chip 728, the location chip 758, and the company chip 122.

The optional personal profile chip 318 is any storage medium associated with the individual 30. For example, the personal profile chip 318 is a microchip or storage apparatus in the personal computing device 1450 carried by the individual 30, is embedded into an article of clothing or an accessory, such as a watch, a ring, a bracelet, or necklace, and/or is stored remotely, such as in the cloud. Generally, the personal profile chip 318 is wirelessly updateable and contains information about the individual 30. Optionally, and preferably, the personal chip 318 is under control of the individual 30. For example, the personal chip 318 is optionally temporarily activated and/or deactivated by an action of the individual 30, such as through use of a manual switch, through a verbal command, and/or through interaction with a screen display linked to a controller of the device. Similarly, the device optionally includes means for selection of a communication range, such as through use of a manual switch, through a verbal command, and/or through interaction with a screen display linked to the communication device and means thereof, such as a communication frequency.

### Personal Profile System

The personal profile system 300 preferably contains valuable and/or private information about the associated individual 30. As such, security of the information is optionally and preferably protected. The protected information that is optionally encoded and/or encrypted allows the individual 30 to interact with one or more companies 120 in a manner mutually beneficial to the individual 30 and the company 120. In a first example, the individual 30 enters the volunteered data 360 into the personal data 305 that they are seeking a particular gismo. The personal data 305 is classified by the classifier 600 into the personal profile information 370 of the personal profile system 300 and matched using the matching system 130 to a gizmo product of one of the linked companies 123. The location of the gizmo for sale is provided by the analyzer 620 via individualcast 664 to the individual 30. The linking system thereby benefits the individual 30 and the company 120. Multiple examples are provided, infra. Notably, the company/profile matching system 100 additionally applies to property 40, goods, services 50, and/or location 70 as described supra.

Generally, any security, protection, and/or encryption method is optionally used to protect information maintained by the personal profile system 300, such as in the personal chip 318.

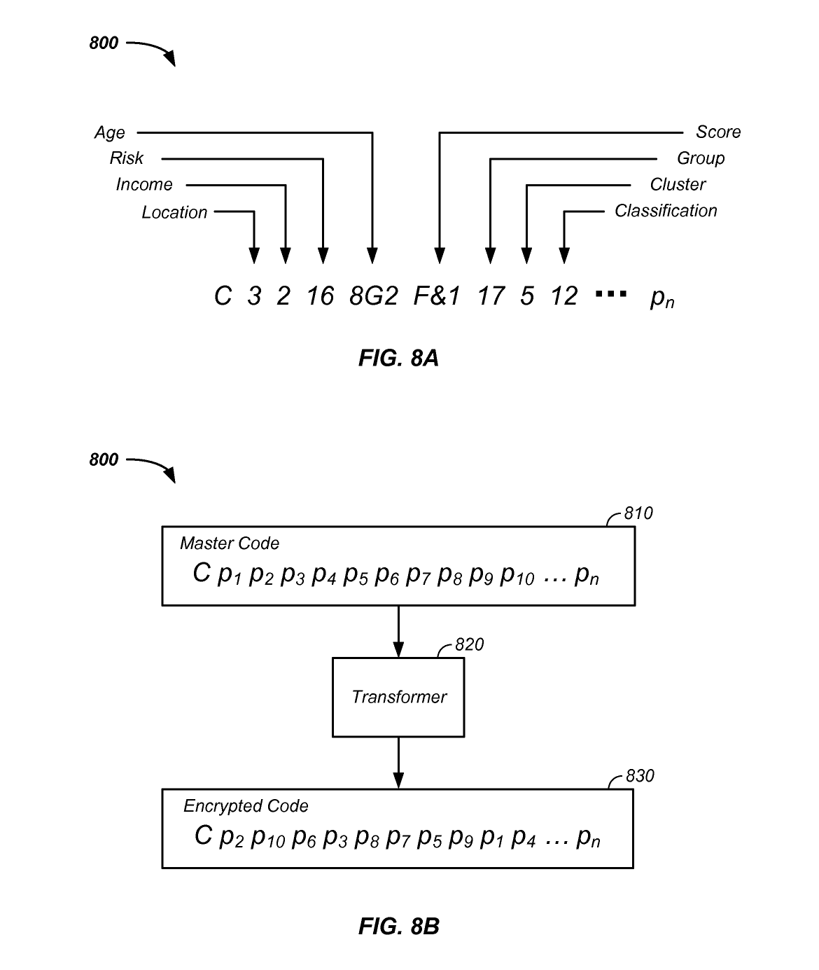

Herein, one non-limiting encryption example is presented. Referring now to FIG. 8A, information about the individual 30 is maintained in any digital format. For instance, answers to a series of questions, derived information, input information, and/or any information related to the individual 30 is maintained in a string, series of data points, registers, cells, memory locations, or the like. For clarity of presentation, a string of coded responses representative of information is illustrated. For instance, the individual 30 represented is in a third location, of a set of n locations known to a master system or master code 810, has a second level income, and has a risk tolerance of 16. Generally any alphanumeric and/or symbolic code of any length is used to represent the individual 30 in one or more categories, such as age, score, group, cluster, or classification. Referring now to FIG. 8B, a transformer 820, encoder, and/or encryptor updates, aligns, and/or realigns information about the individual 30 into an encrypted code 830, which is code accessible to the external system 740. The external system 740 optionally interacts with the individual 30 through use of the encrypted code. For example, the external system 740 optionally interacts with anyone passing a geographic location 70 when the risk score exceeds the value of 12. Herein, the risk score is illustratively shown as the fourth storage point, which is coded as the third parameter, p3, known to the master code as risk tolerance. In this example, now the external system 740 individualcasts 664 to the individual 30 the opportunity to go bungee jumping, skydiving at the next highway exit, or gambling through the door to the left. The external system 740 does not know explicit information about the individual 30, but knows to advertise to this individual 30 based upon the risk tolerance score, p₃. Optionally, the external system 740 is a subscriber or purchaser of the encrypted code information, but is not privy to the particular information leading to the encrypted code. Several examples follow to further illustrate the idea.

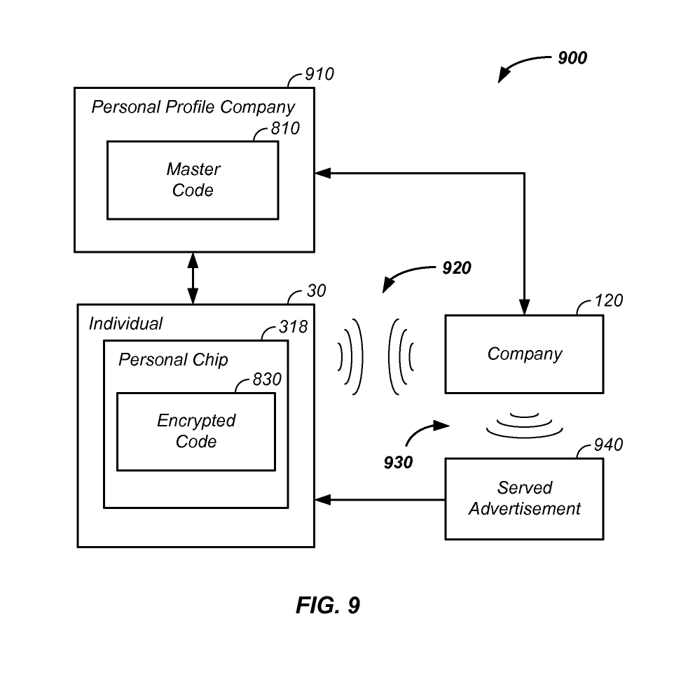

Referring now to FIG. 9, a personal advertising system 900 is illustrated. Generally the individual 30 trusts his/her private information with a personal profile company 910 that maintains the master data and an associated master code 810. The master code translates the personal information of the individual 30, as described supra, and places that encrypted information in the cloud or preferably onto the personal chip 318. The company 120 receives information about the individual 30, such as in a first wireless communication 920. Based on a relationship of the company 120 with the personal profile company 910 that maintains the confidential information of the individual 30 but releases coded information about particular preferences, the company 120 serves an advertisement, such as through a second wireless communication, to the individual 30, such as via the web or via the personal computing device 1450 of the individual 30. Optionally and preferably, the individual 30 maintains control of timing and elements of release of their personal information to the company 120. Optionally, any of the wireless communication 930 is through the world wide web.

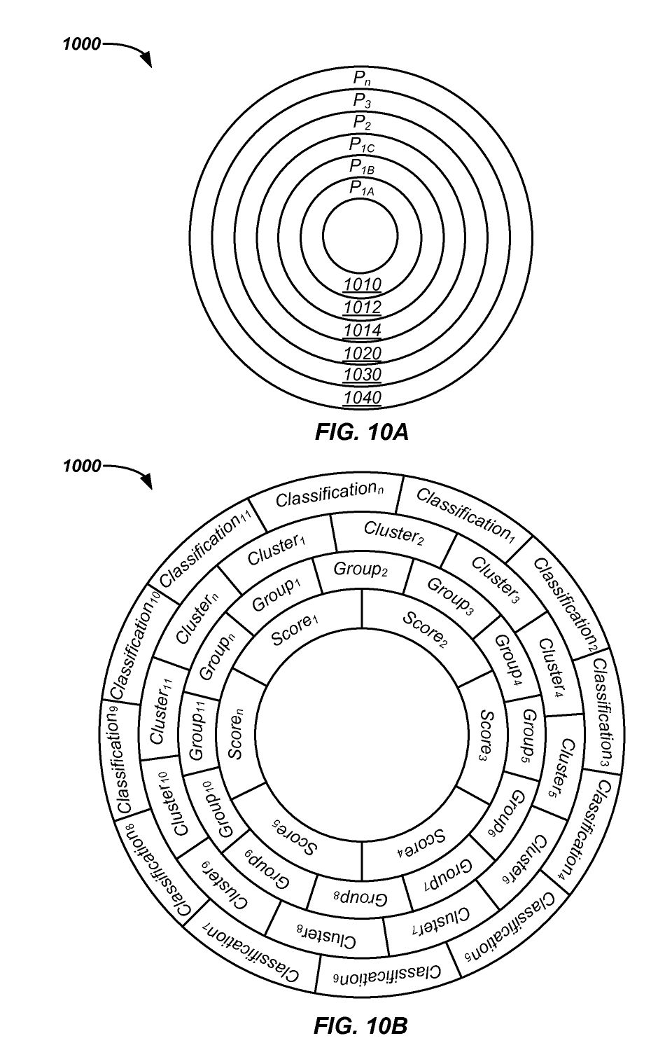

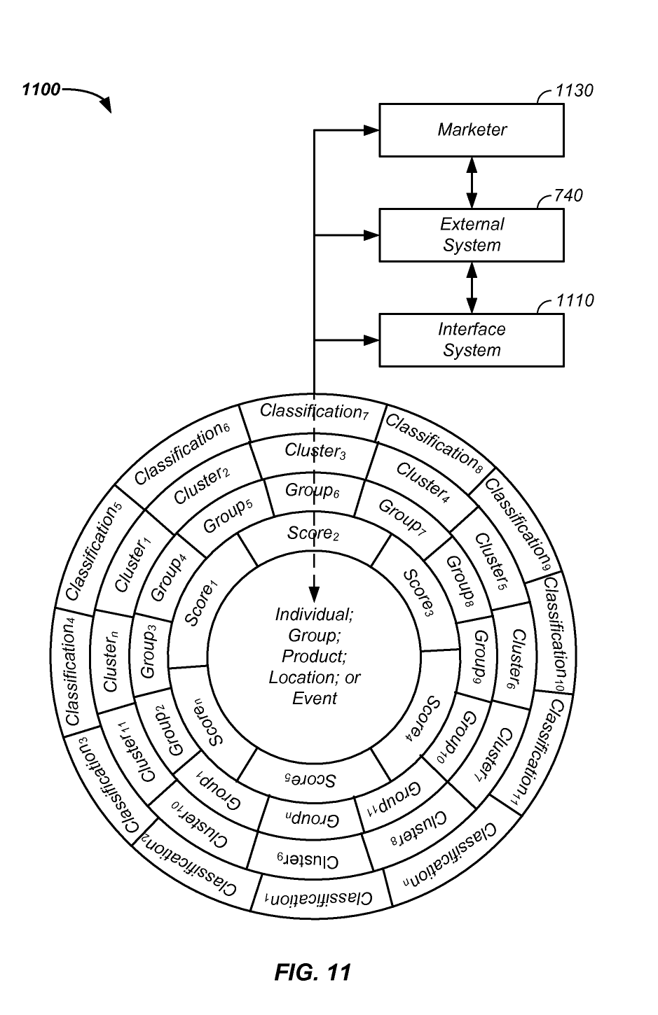

Referring now to FIG. 10, an additional example in a form of an illustrative combination lock representation of the general profile system 110 is provided for a set of parameters 1000. Referring now to FIG. 10A, for example, the set of parameters is a first parameter/first sub-parameter 1010, P_{1A}, a first parameter/second sub-parameter 1012, P_{1B}, a first parameter/third sub-parameter 1014, P_{1C}, a second parameter 1020, P₂, a third parameter 1030, P₃, and an n^{th} parameter 1040, Pₙ, where any number of parameters are recorded representing any information. Referring now to FIG. 10B, a parameter wheel, dial, or lock representation of four parameters is provided where the first parameter is a score of the individual 30, the second parameter is a group assignment of the individual 30, the third parameters is a cluster of the individual 30, and the fourth parameter is a classification of the individual 30. The individual 30 is now optionally depicted as the combination that aligns the set of parameters, as further described infra. Referring now to FIG. 11, the individual 30, group 60, product 40, and/or event 50 represented by the combination lock depiction is depicted after rotation of the lock to the open position. As represented, the open position shows that the individual 30, group 60, product 40, event 50, and/or location 70 is represented by the second score, sixth group, third cluster, and seventh classification. This open combination is communicated to an interface system 1110 which in turn communicates with the business 120, the external system 740, and/or marketer 1130. Optionally, the business 120, marketer 1130, and/or external system 740 communicates directly with the individual 30, such as through the personal chip 318, personal identification system 1410, and/or personal communication device. More generally, in the company/profile matching system 100, the company 120 having a widget matching the open lock combination of the individual 30 is matched with the individual 30 using the matching system 130.

The inventor notes that the visual combination lock depiction of the parameters in FIGS. 10-13 merely conveys the idea and that the matching of parameters is optionally visually depicted differently and is coded and/or is represented as pointers, cells, vectors, and/or arrays in practice.

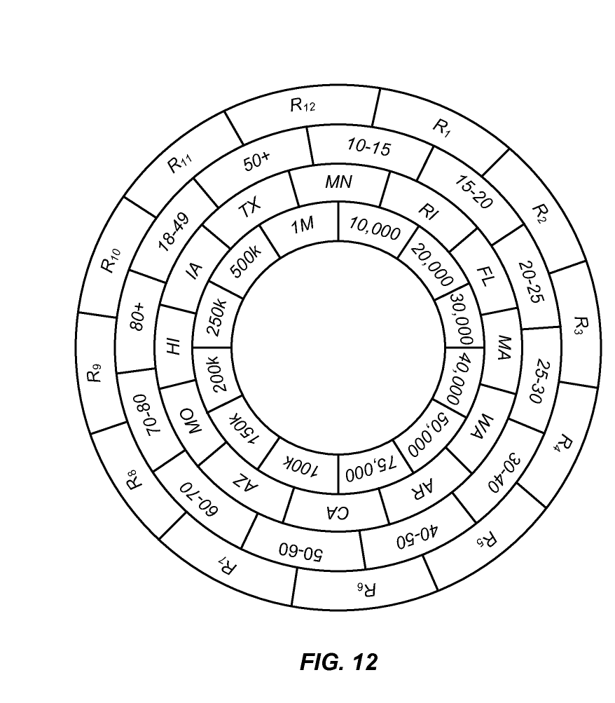

Referring now to FIG. 12, yet another combination lock representation of the personal profile information 370 is depicted. In this representation, four parameters are depicted, income, state of residence, age, and a response code. Again, a potential marketer 1130 is matched to an open combination of the individual 30. Notably, more than one combination optionally opens the lock. For example, a marketer's first parameter income requirement of the individual 30 of at least two hundred thousand dollars has four open positions, second parameter residence requirement in the Midwest has four open positions, a third parameter age requirement of forty or below has five open positions, and a fourth parameter response requirement of six has one open position yielding eighty possible open lock combinations (4×4×5×1).

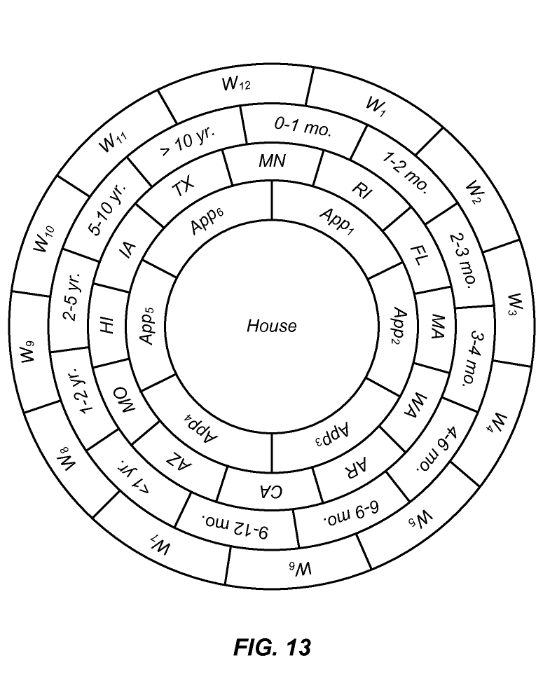

Referring now to FIG. 13, a combination lock representation of a piece of property 40 is presented. In this example, a house is represented using four parameters, an appliance, a state of location, a period since initial sale, and warranty term sheet. Again, a company 120, external system 740, and/or marketer 1130 optionally interacts with the property 40 through the goods chip 718 to obtain goods information 716. In this case, a company might send a car through a neighborhood and wirelessly map property 40 of willing individuals 30 to allow matching of goods or services, such as a whole home and appliance warranty, to the individual 30. For instance, if all appliances, painting history, upkeep requirements, plumbing, heating, electrical, possessions, and/or property 40 in the home were linked to the home, where the home itself optionally contains a home chip containing information about the home, then the passing car optionally obtains a complete picture of property of the individual 30 at that location and the linked companies 123 can bid on maintaining all or part of the possessions of the individual 30.

### Personal Identification System

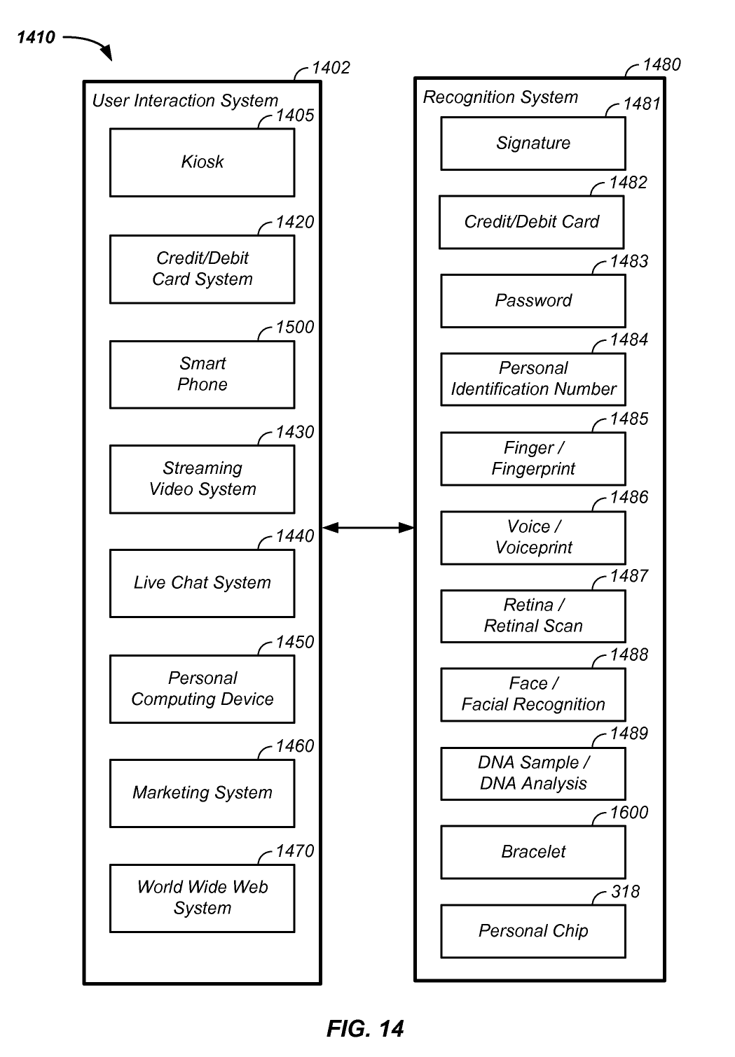

Referring now to FIG. 14, an example of the personal identification system 1410 is provided. Generally, the personal identification system 1410 uses any means for determining the identification of the individual 30. Herein, for clarity of presentation and without loss of generality, the personal identification system 1410 is described using a user interaction system 1402 and/or a recognition system 1480. Generally, the individual 30 interacts with the user interaction system 1402 and provides evidence of identity using the recognition system 1480. Generally, any of the optional recognition system 1480 identification processes are used in conjunction with any of the optional systems of the user interaction system 1402. The user interaction system 1402 and recognition system 1480 are further described, infra.

### Interface System

Still referring to FIG. 14, a user interaction system 1402 is an example of the interface system 1400. The user interaction system 1402 that the individual 30 physically interacts with is further described. Generally, the user interaction system 1402 is any physical and/or wireless digital device that is used to interact with the individual 30. Examples of user interaction systems 1402 include, but are not limited to, one or more of: a kiosk 1405, a credit and/or debit card system 1420 or reader, a smart phone 1500, a streaming video system 1430, a live chat system 1440, the personal computing device 1450, a marketing system 1460, and/or the world wide web system 1470.

### Recognition System

Still referring to FIG. 14, the recognition system 1480 is used to acquire personal identification information that identifies the particular individual 30. Examples of personal identification information provided by the individual 30 include, but are not limited to: a signature 1481, a credit and/or a debit card 1482, a password 1483, a personal identification number 1484 or personal identification code, a fingerprint 1485, a voiceprint 1486, a retina for a retinal scan 1487, the individual's face for facial recognition 1488, a DNA sample 1489, such as a real-time providing of a DNA sample to the kiosk 1405, a real-time DNA analysis, a blood sample, an interstitial fluid sample, presence of a personal identification bracelet 1600, and/or interaction with the personal chip 318.

### Interface/Recognition System Interaction

In a first example, the kiosk 1405 is used to identify the individual 30 at a particular location 70, such as at a retail outlet, bar, nightclub, and/or at a security checkpoint. The kiosk 1405 is optionally configured with one or more sensors and/or systems to perform any chemical and/or physical test. Examples of chemical tests/chemical testing systems include, but are not limited to: a blood alcohol monitor, a drug monitor, a DNA monitor, and/or a system used to accept and/or use any recognition system 1480 element, such as the DNA sample 1489. Examples of a physical test/physical testing system include, but are not limited to: analysis of the signature 1481, fingerprint 1485, voiceprint 1486, retina 1487, face 1488, or DNA sample 1489.

In a second example, the smart phone 1500 and/or the personal computing device 1450 uses a camera and/or a text system to implement the streaming video system 1430 and/or the live chat system 1440, respectively. In a first case of the streaming video system 1430, the face 1488, and/or retina 1487 is used to identify the individual 30. In a second case, the live chat system 1440 is used to identify the individual 30 through use of the password 1483, the personal identification number 1484, and/or through a real-time interaction where information such as a personal history, environmental information, mother's maiden name, and/or the password 1483 are provided to identify the individual 30.

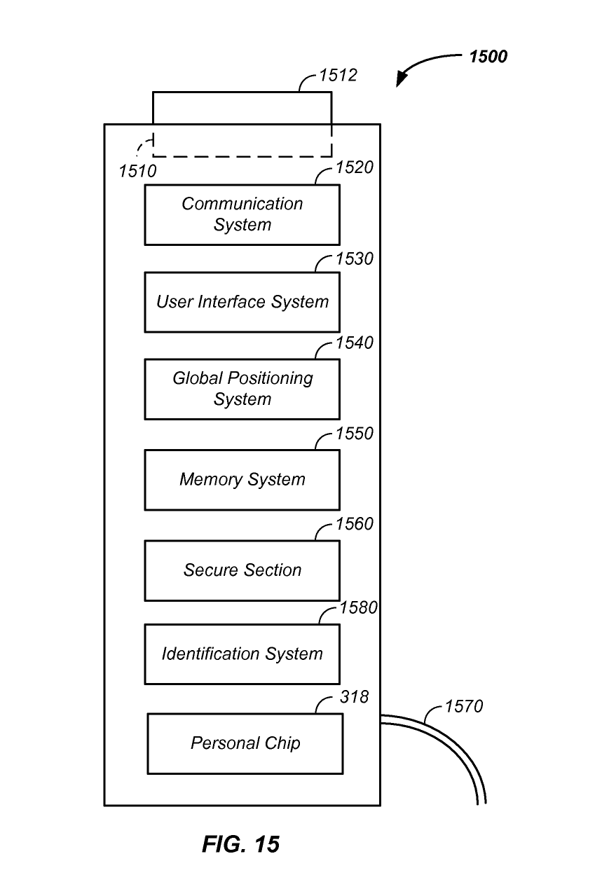

Referring now to FIG. 15, in a third example, functionality of the smart phone 1500, tablet, and/or phablet is optionally used as part of the personal identification system 1410. Use of the smart phone 1500 as part of the personal identification system 1410 is further described, infra.

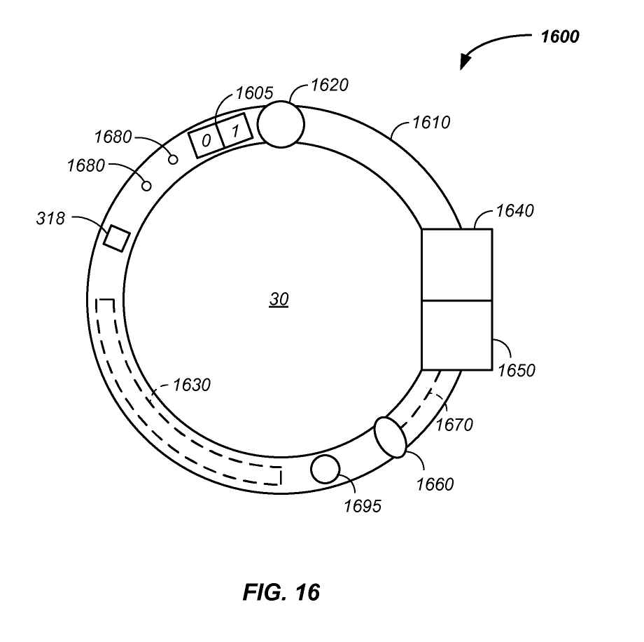

Referring now to FIG. 16, in a fourth example, the bracelet 1600, such as a personal identification bracelet is optionally used as part of the personal identification system 1410 to identify the individual 30. Use of the bracelet 1600 as part of the personal identification system 1410 is further described, infra.

In a fifth example, the smart phone 1500 and/or the personal computing device 1450 are used to confirm and/or communicate proximity of the bracelet 1600 to a system, such as an auxiliary system, a peripheral system, an authority system, and/or an ignition interlock system.

In a sixth example, functionality of any element of the interface system 1400, such as a global positioning system (GPS), vehicle ignition interlock system, drug monitoring system, health monitoring system, and/or a computer coded interface system are associated with the individual 30 using any element of the recognition system 1480.

In a seventh example, output of the interface system 1400, personal identification system 1410, and/or recognition system 1480 is communicated to the external system 740, such as: an authority system, a medical system, an emergency system, a support network, a family member, an employer, a friend, the company 120, the matching system 130, and/or a ticket collecting kiosk at a sports or music venue where the ticket is an identification of the individual 30, where the kiosk 1405 confirms that individual has a ticket to the event.

Generally, any computer code/data analysis system is optionally used in any interface systems 1400 and/or user interaction system 1402 to recognize, confirm, and/or reject any of the recognition system 1480 samples.

### Smartphone

Referring again to FIG. 15, as described supra, the company/profile matching system 100 optionally uses a smartphone 1500. The smartphone 1500 herein also refers to a feature phone, a mobile phone, a portable phone, a cell phone, a tablet, and/or a phablet (phone tablet). More generally, for clarity of presentation the smartphone 1500 is optionally any personal computing device 1450. The smartphone 1500 contains a number of hardware and software features, which are optionally usable in combination with the company/profile matching system 100 and/or with the bracelet 1600, such as a hardware port 1510, a communication system 1520, a user interface system 1530, a global positioning system 1540, a memory system 1550, a secure section 1560, an identification system 1580, and/or a power inlet 1570 or power supply.

The hardware port 1510 of the smartphone 1500 typically contains one or more electro-mechanical connectors designed to physically link to an external hardware element. Examples of connectors include a power supply port, a universal serial bus (USB) port, an audio port, a video port, a data port, a port for a memory card, a multi-contact point connector, and a multi-pin connector, such as a 30-pin connector on a n-pin connector where n is a positive integer.

In one embodiment, one or more of the hardware ports 1510 interface to a bracelet receiver 1512. The bracelet receiver 1512 optionally wirelessly interfaces the bracelet 1600 to the smart phone 1500. For example, the bracelet receiver 1512 receives input from the bracelet 1600 or wireless communication device 1630 of the bracelet. In a particular example, the wireless communication device 1630 is a radio-frequency identification tag (RFID), which transmits signal over a limited distance, such as in the centimeters to many meters range. Generally, the distance of communication is a function of frequency, with lower frequencies of communication being in the kiloHertz range that transmit for centimeters and the higher frequency gigaHertz range transmitting for hundreds of meters. Herein, for use of confirming that an individual 30 is proximate the smartphone 1500, the preferred frequency of the wireless communication is in the 5 to 7000 megaHertz range, which transmits the signal from 1 to 100 meters or a lower frequency range transmitting from 10 to 100 centimeters.

The bracelet receiver 1512 is optionally produced for law enforcement, such as a court ordered home arrest bracelet. As such, the bracelet receiver 1512 optionally contains a number of features associated with tracking the individual 30, such as recognition of being removed and replaced from the smartphone 1500, secure programming or code, and/or a law enforcement programmable chip.

Each of the communication system 1520, user interface system 1530, global positioning system 1540, and/or memory system 1550 of the smartphone 1500 is optionally used as part of the a company/profile matching system 100. In a first example, the individual 30 uses the smartphone 1500 to confirm identity of the individual 30 through the smartphone 1500/bracelet 1600 localized communication system.

The secure section 1560 of the smartphone 1500 is used to impede tampering by the individual 30, a potential crook, and/or an outsider, where impedance resists reprogramming any element of the identification/peripheral device.

The optional identification system 1580 of the smartphone 1500 is used as a primary identification of the individual 30 or preferably as a secondary identification of the individual 30, where the bracelet 1600 is the primary identification of the individual 30. Examples of use of the smartphone 1500 for identification of the individual 30 include use of video of the individual 30, a photo of the individual 30, a scan of the iris or retina 1487 of the individual 30, use of a fingerprint 1485 of the individual 30, and/or use of voice recognition 1486 of the individual 30 at time of identification along with reference data and a comparison algorithm. Generally any means of identification using the smartphone 1500 is optionally used.

The power supply connected to the smartphone 1500 is optionally indirectly used to provide power to a passive radio-frequency identification tag embedded in the bracelet 1600, where the passive RFID lacks an integrated power supply.

Optionally, any of the features performed using the bracelet receiver 1512 are optionally performed using a smartphone 1500 application and/or standard feature in combination with internal hardware of the smartphone 1500, such as a wireless receiver.

Optionally, one or more features of the smartphone 1500 is embedded into the bracelet 1600.

### Bracelet

Referring now to FIG. 16, the bracelet 1600 is illustrated. Generally, the bracelet 1600 is worn by a specific individual 30 and is used to identify the presence of the specific individual 30 associated with the bracelet 1600. The bracelet 1600 is optionally circular, annular, or is of a geometry that forms an outer perimeter about a body part, as described herein.

The bracelet 1600 is removable, is removable only with destructive force, or is removable with use of a form of a key. In the first case, the bracelet is removable and is used to determine proximity of an individual 30. The presence of the individual 30 is used to facilitate an action. For example, as the individual 30 is walking up to the individual's vehicle, the bracelet communicates the presence of the individual 30 to the vehicle and the vehicle is automatically unlocked and/or started based on the presence of the individual 30. In a second example, the bracelet 1600 indicates proximity of the individual 30 to the company 120, product 40, event 50, and/or location 70. In the second case, the bracelet is not readily removable, but the bracelet is still used to identify presence of the individual 30 to a communication device and/or a peripheral device. The bracelet optionally includes one or more of: an on/off control 1605, a security ring 1610 or loop, a security mechanism 1620, a wireless communication device 1630, a power supply 1640, a communication system 1650, a motion charged power supply 1660, an internal wire 1670 or wire bundle, an indicator light 1680, and a motion sensor 1695.

The optional on/off switch 1605 allows the individual 30 the ability to broadcast all and/or a portion of a user selected portion of their personal profile information 370, to communicate with the external system 740, to communicate with the business 120, to receive the individualcast 664, receive the groupcast 668, and/or receive the broadcast 662. Optionally, the on/off switch suspends communication for a set period of time and/or to a set range from the individual 30, such as less than 10, 100, 500, 1000, 5000, or 10,000 feet.

The security ring 1610, security band, annular device, loop, or structure optionally circumferentially surrounds a body part of the individual during use in a manner where, along a given plane crossing axially through the individual's body part, an inner perimeter distance or diameter of the security ring is smaller than an outer perimeter distance or outer diameter of an extension of the body part along a longitudinal axis perpendicular to the axial axis on both a first longitudinal side of the bracelet 1600 and on a second longitudinal side of the bracelet 1600. The security ring 1610 is preferably formed of a rigid material, such as steel, stainless steel, a hardened material, and/or material difficult to cut, remove, or alter.

The optional security mechanism 1620, such as a lock, crimp, or seal, is used to affix the security ring 1610 about the body part of the individual 30 in a manner that is not readily removable without breaking or altering of the security mechanism 1620. The seal on the security mechanism 1620 optionally forms a two or three dimensional mark using a softer material than the security ring 1610, where the unaltered mark represents a non-tampered seal and/or an authority symbol, such as from a police or legal system. For example, the security ring 1610 is crimped at the security mechanism 1620 to form a continuous loop about the body part of the individual 30. Optionally, the crimping mechanism is engraved so as to form the mark on the bracelet 1600 when the crimping of the bracelet 1600 is performed.

The wireless communication device 1630 is optionally a radio-frequency identification system or tag. The radio-frequency identification tag is optionally powered by a battery electrically connected to the radio-frequency identification tag or is powered by an electromagnetic field used to read the radio-frequency identification tag.

The optional power supply 1640, such as a battery, is optionally embedded within the bracelet 1600, is semi-embedded into the bracelet 1600, is attached to the bracelet 1600, or is replaceable affixed to the bracelet 1600.

The optional communication system 1650 is any device used to digitally identify the presence of the bracelet 1600 and hence the specific individual to an outside digital system and/or to the authority system, where the communication system 1650 is not the radio-frequency identification tag.

The optional motion charged power supply 1660 is used to charge an electrically coupled power consuming device in the bracelet 1600, such as the wireless communication device 1630, the power supply 1640, the communication system 1650, and/or a mechanical winding mechanism. Additionally and/or optionally, the motion powered power supply 1660 is used to run a current or a voltage through the internal wire 1670, where cutting the internal wire 1670 results in an electrical short causing the bracelet 1600 to refuse to identify the presence of the individual 30 to the peripheral device and/or to contact an authority person or the authority system.

The optional indicator(s) 1680 and/or smart phone, which are electrically and logically connected to a power supply and logic unit, are used to inform the individual 30 that the bracelet 1600 is any of: on, off, transmitting, receiving, within range of a vehicle, within an acceptable boundary, outside an acceptable boundary, inside a court ordered boundary, outside of a court ordered boundary, in communication with the authority system, in range of the authority system, out of range of the authority system, functioning, and/or malfunctioning.

The optional motion sensor 1695, detects motion along the x-, y-, and/or z-axes. The motion sensor 1695 uses the detected motion to determine shake of the individual 30. Shake of the individual 30 is optionally used to determine alcohol impairment of the individual 30, an epileptic seizure of the individual 30 or patient, and/or to indicate that the individual was just in an accident. The use of shake of the individual 30 is an example of a secondary test or auxiliary test of impairment. Optionally, the motion sensor 30 is placed into the smartphone 1500.

Any element of the bracelet 1600 is optionally implemented in a wearable device, in a device associated with the personal chip 318, in the smart phone 1500, and/or in the personal communication device of the individual 30. The wearable device is held to the individual with a band, strap, ring, clip, and/or through use of a flexible material, such as a piece of fabric, cloth, and/or leather.

### Personalized Advertisements/Personalized Microsites

Heretofore, many examples emphasized the matching of the individual 30 to the company 120. However, as described supra, the matching system 130 optionally matches any two profiles.

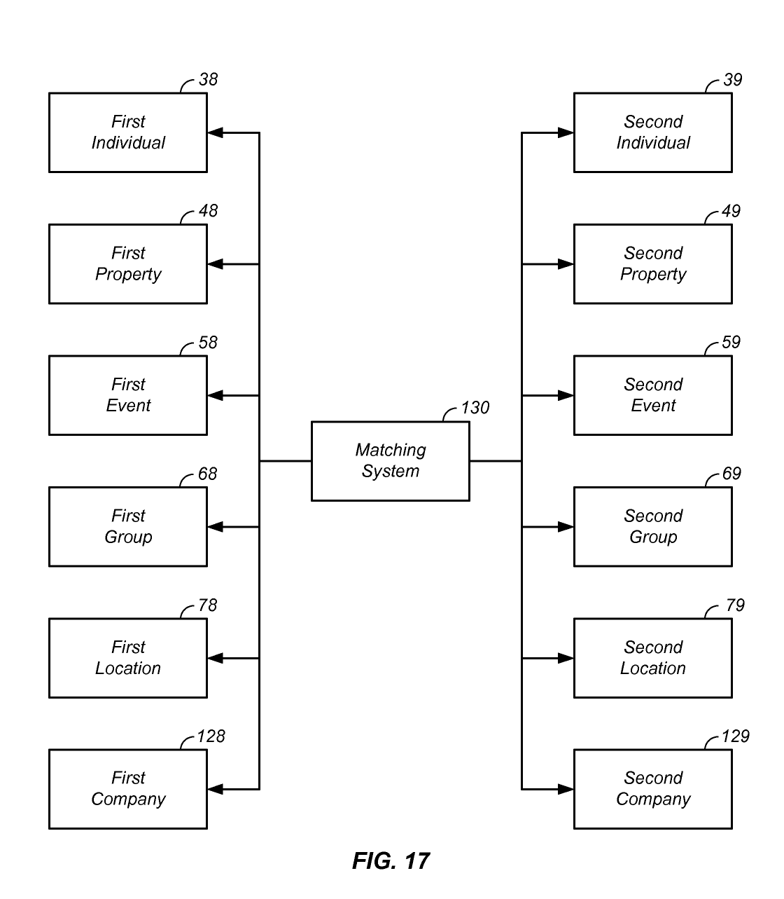

Referring now to FIG. 17, the matching system 130 is further described. As depicted, the matching system 130 optionally matches a first individual 38 to a second individual 39, to a second property 49, to a second event 59, to a second group 69, to a second location 79, and/or to a second company 129. Similarly, any of a first property 48, first event 58, first location 68, first group 78, and/or first company 128 are optionally linked to any of the second individual 39, the second property 49, the second event 59, the second group 69, the second location 79, and/or the second company 129. The process is optionally repeated n times where n is a positive integer. Generally, a profile is optionally attached to any physical device and/or is associated with any digital representation.

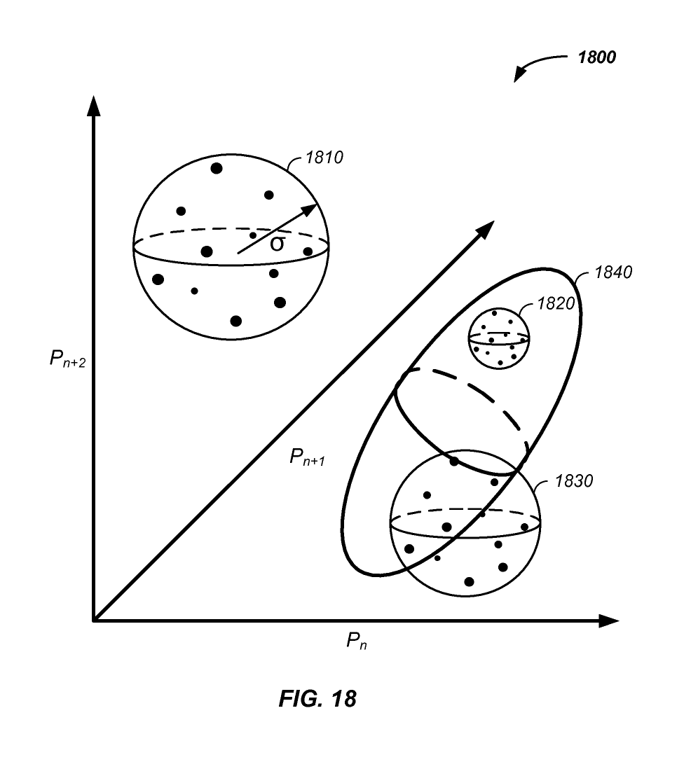

Referring now to FIG. 18, a process of matching profiles 1800 is figuratively illustrated. In FIG. 18, a three dimensional representation of three parameters Pₙ, Pₙ₊₁, and Pₙ₊₂ is provided, such as age, income, and location. Generally, the three-dimensional representation represents any number of dimensions. In a first cluster 1810, eleven individuals are identified within a radius, σ, in the three dimensional space. A second cluster 1820 of individuals is smaller, indicating tighter parameters and/or more closely related individuals. A third cluster 1830 is close to the second cluster 1820, which indicates two similar, but distinct, groups. A fourth space 1840 represents parameters sought by the company 120 for customers of a particular gizmo. Clearly, the company 120 should not advertise the gizmo to the first cluster 1810 as the requirements of the customers sought by the company 120 do not overlap parameters of the individuals in the first cluster 1810. Similarly, the company 1840 should advertise the gizmo to the second cluster 1820 as all of the individuals in the second cluster are within the space that the company 120 seeks to advertise to. For the third cluster, the company 120 can see that some of their customer requirements match individuals in the third cluster 1830. The company can choose to advertise to the third cluster 1830 based on an advertising/return assessment, tighten the requirements to exclude, loosen the parameter requirements to include, advertise to individuals with space 1840, and/or analyze again with a second set of parameters. The company optionally sends a groupcast 668 to an overlapped group and/or an individualcast 664 to individuals 30 that have parameters in their respective personal profiles intersecting with the parameters set by the company 120 for potential sales of their gizmos.

### Personalized Advertisements/Personalized Microsites

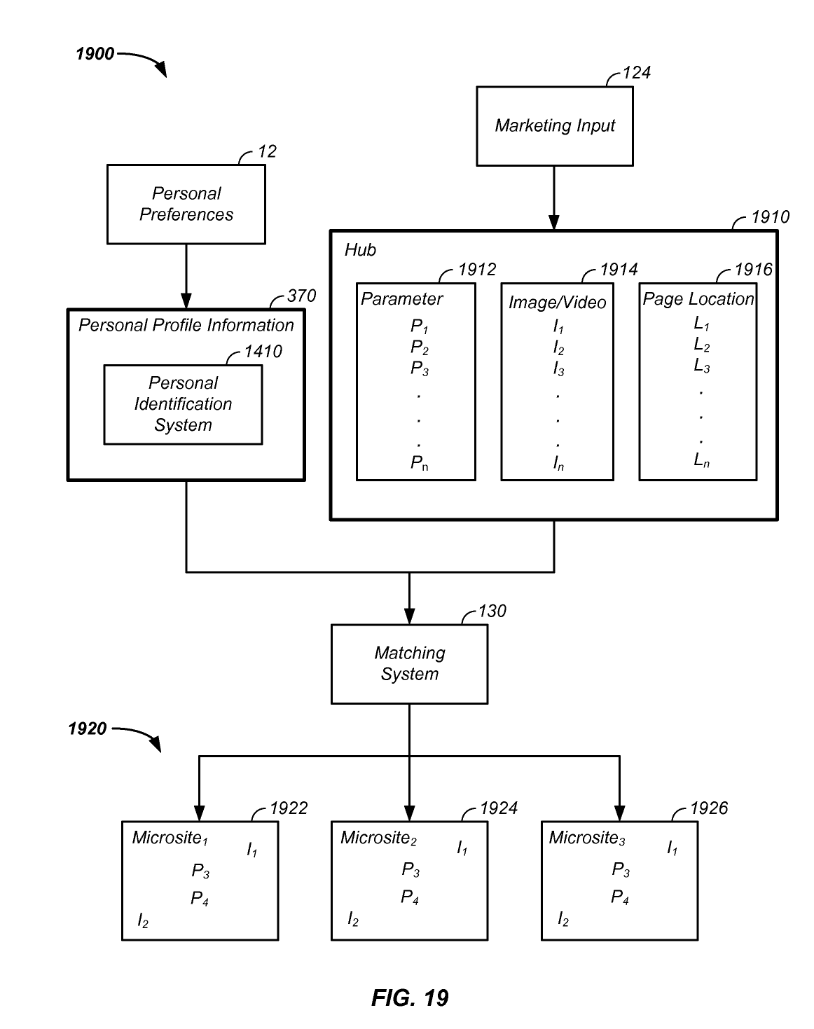

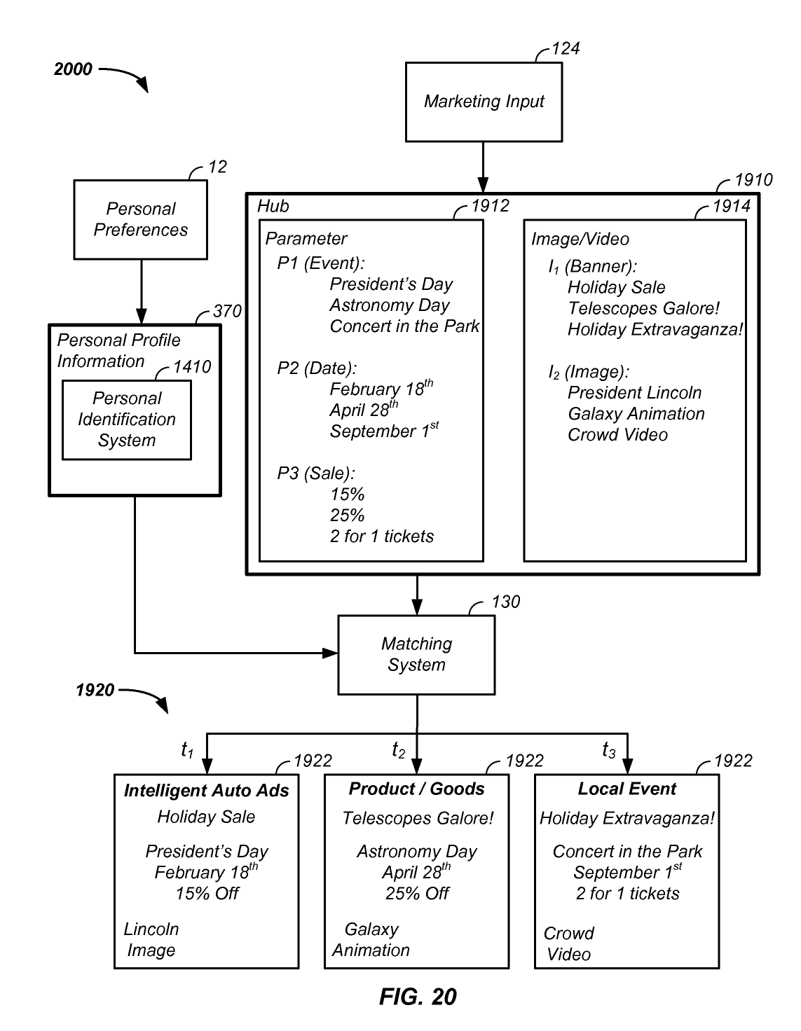

Referring now to FIG. 19 and FIG. 20, personalized advertisements 1900 are described, which are optionally in the form of one or more microsites delivered to a personal computer, the smart phone 1500 of the individual 30, tablet, a personal computing device of the individual 30, a smart television, and/or a smart phone.

In yet another embodiment, the invention comprises a hub apparatus and method of use thereof for serving personalized advertisements and/or for updating microsites, where a controller, programmer, automated code, and/or user updates a hub with a limited number of parameters for a subsequent broadcast 662, common to a group for a subsequent groupcast 668 and/or common with the individual 30 for a subsequent individualcast 664. For example, a cluster analysis is used comparing advertising parameter requirements for the company 120 with a set of individuals, where the set of individuals are mapped into the n-dimensional parameter space using their respective personal profile information 370. In another example, an individualcast 664 is made to the individual 30 based upon an overlap of advertising parameters of the company 120 with the personal profile information 370 of the individual 30 as determined by the matching system 130. Optionally, the resulting advertisement is in the form of the personalized advertisement 160, such as delivered to the smart phone 1500, personal computing device, personal computer, and/or to the personalized microsite 162. Herein, advertisement to a microsite is used to described any advertisement. For example, the microsite presentation layout and content of information is optionally similarly formatted in any digital advertisement.

### Hub

Subsequent to identification of matching parameters of the personal profile information 370 of the individual 30 with advertising parameters of the company 120, a hub is optionally used to update parameters of an advertisement. Examples of common updateable hub parameters to at least a plurality of advertisements include a piece of information, a location of the information, and/or a presentation of the information. The information is optionally to any piece of property 40 or gizmo.

Referring now to FIG. 19, a hub 1910 is optionally used to provide information for a particular advertisement and/or for a particular microsite 1920. In the case of the particular advertisement parameters matching a set of individuals, the advertisement is sent to the group 60 via a groupcast 668 and/or is used to form a traditional microsite. For example, a database within the hub 1910 is populated with information or data, such as marketing input 124 that is subsequently distributed to and/or implemented within code and/or in a presentation of one or more microsites 1920. Examples of common information or data within microsites 1920 that is optionally filled using a database of the hub 1910 include any of:
perceived or rendered information, such as:
   textual information;
   non-textual information, such as:
      a static image;
      an animated image;
      audio; and
      video; and
   interactive information; and
internal or hidden information, such as:
   a meta-tag;
   metadata; and
   comments.

### Microsite

A microsite is often used to provide an editorial or additional information on a specific topic. Additionally, microsites provide an opportunity for additional contextual advertising and/or to create keyword rich content to enhance search engine rankings on a specific topic.

Still referring to FIG. 19, generally a specific microsite contains a limited number of website elements. A set of microsites 1920 often contain a subset of common website elements. As described, supra, updateable common microsite elements include: a string of text, microsite information, an image, an animation, a video, a banner, a background, a skin, and/or any other microsite graphical element.

### Hub/Microsite Interrelationship

Still referring to FIG. 19, a hub/microsite updating system 1900 is illustrated. The hub/microsite updating system 1900 includes the hub 1910 and the set of microsites 1920 at least intermittently in communication with the hub 1910. As described supra, the population of the microsites 1920 with information is optionally driven using the matching system 130 to match the delivered information with personal profile information 370 of the individual 30 and/or with information matching a cluster of parameters of the group 60, based on the group information 62, and/or individual profiles of members of the group 60.

Generally, the hub 1910 is provided data and the hub 1910 is subsequently used to populate parameters or fields of a plurality of microsites 1920. In this example, the hub 1910 is illustrated as having a number of parameters 1912, images/videos/animations 1914, and/or locations 1916 for presentation of the parameters 1912 or images 1914. However, generally the hub contains any combination of the data or microsite elements described above. The set of microsites 1920 is illustrated as a first microsite 1922, a second microsite 1924, and a third microsite 1926. However, generally the set of microsites comprises n microsites where n is a positive integer, such as greater than 2, 10, 100, 1000, 10,000, 50,000, or 100,000. As illustrated, a first common image (I₁) from a hub image database 1914 is automatically coded into and/or presented in the upper right hand corner of each of the first, second, and third microsites 1922, 1924, 1926. The particular location of the first image is provided by a location field 1916, where a location in the location field is optionally constant, varied across the microsites 1920, and/or is varied as a function of time. Similarly, a second common image (I₂) from the hub 1910 image database 1914 is automatically coded into and/or presented in the lower left hand corner of each of the first, second, and third microsites 1922, 1924, 1926, where the second location is optionally provided by the location field 1916. The parameter field 1912 optionally contains a reference to any of the data types described above. In this example, text is provided in the third and fourth parameters memory locations (P₃, P₄) and the text from the third and fourth parameters memory locations is coded into and/or presented in the middle of each of the microsites 1922, 1924, 1926, where again the position of the presentation of the text is optionally controlled using the location field 1916 in the hub 1910. Generally, any element of the microsites 1920 is optionally controlled and/or updated by the hub 1910. Preferably, information common to a plurality of the microsites 1920 is controlled and/or updated using the data 1930 provided to the hub 1910. Generally, the first microsite 1922 is optionally delivered to the individual 30 and/or group 60, in the form of an advertisement, with first content and/or at a first time, the second microsite 1924 is optionally delivered to the individual 30 and/or group 60 with second content and/or at a second time, and the third microsite 1926 is optionally delivered to the individual 30 and/or group 60 with third content and/or at a third time.

Herein, without limitation and for clarity of presentation, examples of updating a set of advertisements and/or microsites using a hub is described. Referring now to FIG. 20, an example of use of the hub/microsite updating system 1900 is illustrated. As illustrated, the hub 1910 is used to update parameters for the first microsite 1922 as a function of time. Particularly, the first microsite 1922 is illustrated at a first time, t₁, a second time, t₂, and a third time, t₃. Generally, the first microsite 1922 is updated by the hub at any time, hourly, multiple times within a day, daily, weekly, monthly, seasonally, or at particular times defined by the hub data, such as for particular holidays or sales events. Preferably, the microsite 1922 and/or advertisement is updated based upon location and/or preferences of the individual 30 relative to location and/or parameters of a product 40, good, event 50, or service offered by the company 120 using the personal profile information 370 of the individual 30 and optionally the matching system 130.

### Example I

A first non-limiting example of an individualcast 664 is provided. In this example, the individual 30 is driving past an auto dealer. Using the personal profile information 370 of the individual 30 and a communication system, such as in the individual's car, the smartphone 1500, and/or the personal identification bracelet 1600, an advertisement from the company 120 is served to the individual 30, such as through the communication system, smart phone 1500, and/or personal computing device of the individual 30 about presence of the car dealer, directions to the car dealer, a special offer of the car dealer, and/or information about a particular car of the car dealer. Preferably, the advertisement matches a subset of information in the personal profile information 370 of the individual 30, such as the volunteered data 360 of the personal data 305 of the individual, which in this example is a particular car.

### Example II

A second non-limiting example of an individualcast 664 is provided. In this example, the individual 30 is at the auto dealer. Using the personal profile information 370 of the individual 30 and a communication system, such as the smartphone 1500, the personal computing device of the individual 30, and/or the kiosk 1405, an advertisement is served to the individual 30. The advertisement is optionally to the particular car identified by the individual 30 in the volunteered data 360 or is an optional car, which the matching system 130 identifies as both: (1) being available by the car dealer and (2) fulfills particular parameters of the individual 30 based upon the personal profile information 370. For instance, the individual 30 has two kids, likes to ski and mountain bike, and wants a coupe. In this case, the matching system 130 suggests a cross-over sports utility vehicle, which while not in the volunteered data 360 is determined by the matching system 130 and/or analyzer 620 as fulfilling desires of the individual 30, such as based upon the core data 310, psychological data 330, relationship data 340, history data 350, and/or volunteered data 360 of the personal data 305 of the individual 30.

### Example III

In a third example, the company 120 serves an advertisement to the individual 30 based upon analysis of the matching system 130 and/or the analyzer 620 using any information, such as stored on a chip or in the cloud, of the individual 30, property 40, event 50, group 60, and/or location 70.

### Linked Businesses

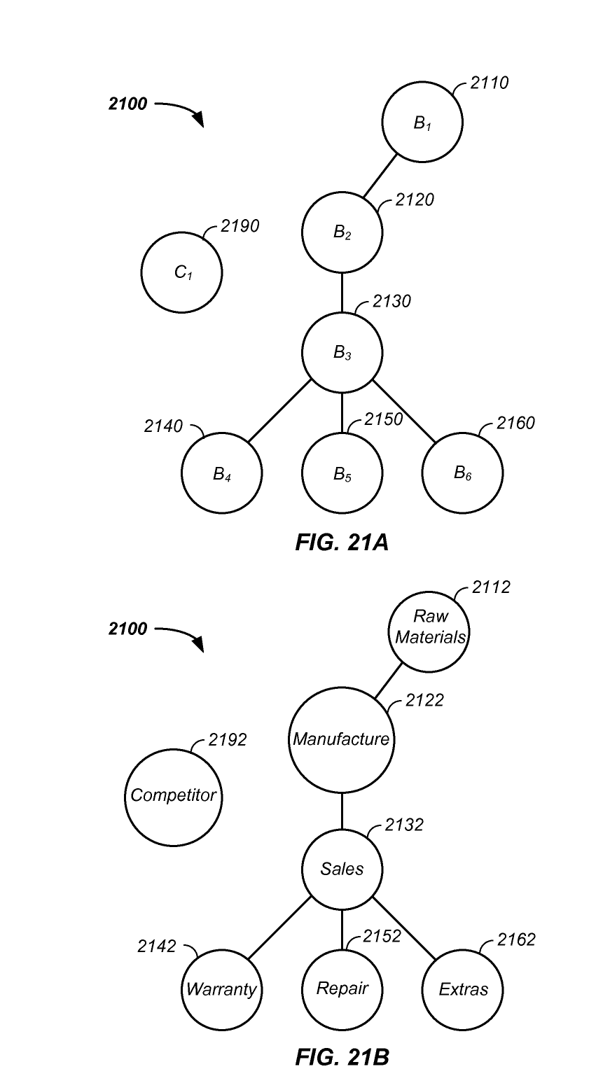

Referring again to FIG. 1 and now to FIG. 21A, the linked companies 123 are further described. In a linked company system 2100, a series of n companies are linked together, where n is a positive integer. As illustrated, a first business 2110, B₁, is linked to a second business 2120, B₂; the second business 2120, B₂, is linked to a third business, B₃; and the third business, B₃, is linked to multiple businesses, a fourth business 2140, B₄, a fifth business 2150, B₅, and a sixth business 2160, B₆. Generally, the linked company system 2100 links any number of businesses in any manner. A competitor 2190, C₁, is optionally not formally linked to at least one business of the linked companies 123.

Referring now to FIG. 21B, for clarity of presentation a non-limiting example is provided to further illustrate the linked companies 123. In this example, a raw materials company 2112 is linked to a manufacturing company 2122, which is linked to a sales company 2132, which is linked to each of a warranty company 2142, a repair company 2152, and an extras company 2162, such as a company that provide accessories to a product 40.

### Reward System

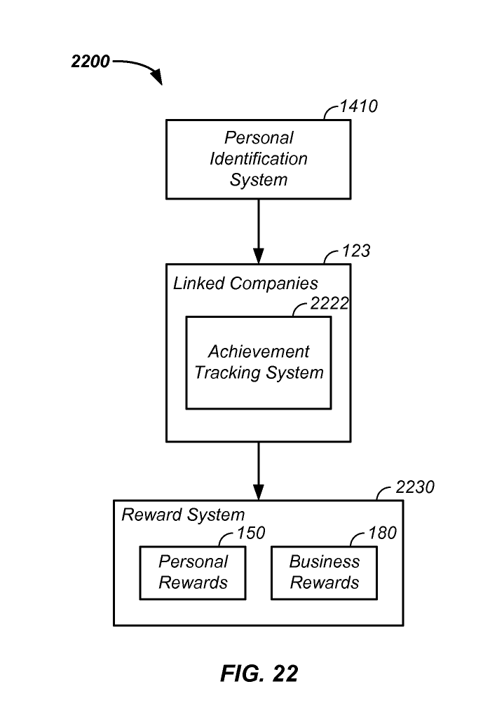

Still referring to FIG. 1 and now referring now to FIG. 22, the linked companies 123 optionally provide an achievement/reward tracking system 2200. For clarity of presentation, a non-limiting example is provided to illustrate the achievement/reward tracking system 2200. The linked companies 123 keep track of activities of the individual 30, such as sales, attendance, performance, interactions with others, signed contracts, and/or history of the individual 30, preferably using the personal identification system 1410 of the individual 30. Achievements of the individual 30 and/or of individual companies of the linked companies 123 are also optionally tracked using an achievement tracking system 2222. Examples of achievements of the individual linked companies include: on-time delivery, a price target achievement, a limited number of recalls, sales, contribution to sales, and/or a cost reduction. Additional examples of achievements of the individual comprise actions of the individual, such as attending a rehabilitation class, passing a chemical test, and/or performing a good deed. A reward system 2230 facilitates distribution of rewards to the individual 30 using the personal rewards system 150 and the personal reward distribution system 152 and/or facilitates distribution of the business rewards to the individual companies of the linked companies 123 using the business rewards system 180 and the business reward distribution system 182.

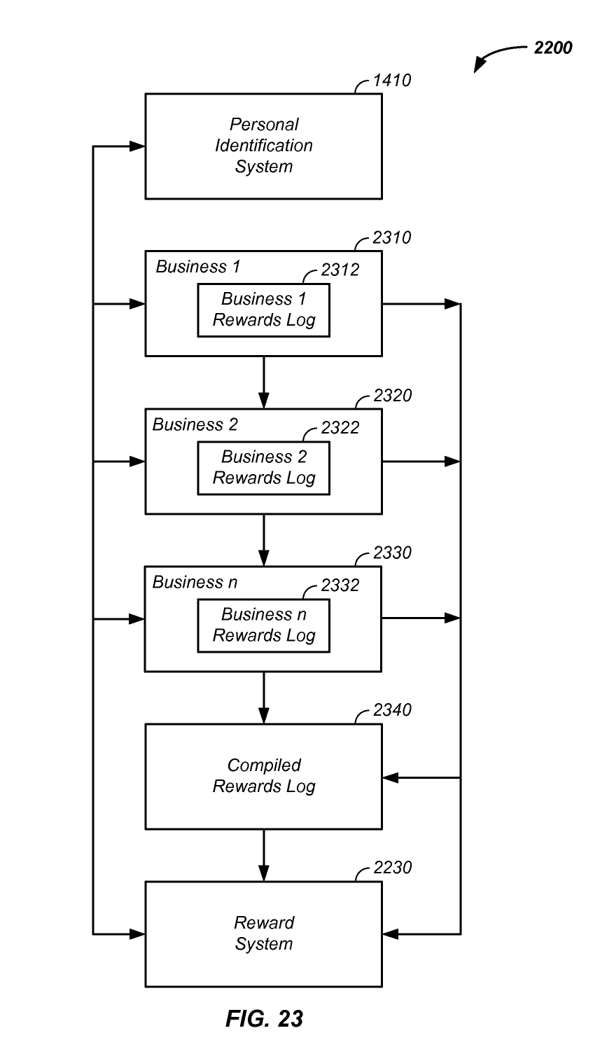

Referring again to FIG. 22 and now to FIG. 23, the achievement/reward tracking system 2200 is further described. Generally, one or more businesses of the linked companies 123 produce one or more achievement/reward logs. The achievement/reward logs are optionally in the form of digital certificates. For clarity of presentation and without loss of generality, the achievement/reward logs are described as recording rewards, where the rewards are optionally linked to the individual 30, such as through use of the bracelet 1600 and/or personal chip 318, and/or are linked to one or more of the linked companies 123.

Referring now to FIG. 23, as illustrated, a first business 2310 generates a first reward log 2312, which is communicated to a second business 2320, to a compiled rewards log 2340, and/or to the reward system 2230. The second business 2320 optionally generates a second reward log 2322 and/or securely amends the first reward log 2312 to the second reward log 2322, which are provided to the compiled reward log 2340 and/or the reward system 2230. The process of producing and/or amending reward logs is optionally repeated n times, such as with an n^{th} business 2330 into a n^{th} reward log 2332, where n is a positive integer.

### Data Authenticity

Optionally, data gathered by any element of the company/profile matching system 100 is recorded, verified, transmitted, and/or securely transmitted in a manner verifying authenticity, such as through use of a digital certificate, an electronic handshake, or through use of a checksum. For example, in the case of the bracelet 1600/company 120 combination, the data authenticity indicates that the specific individual 30 associated with the bracelet 1600 is present and that the information transmitted is secure, such as for use in a financial transaction, purchase, and/or legal proceeding.

### Secure Transactional Stamp

In another embodiment, the personal profile system 300, personal chip 318, and/or personal identification system 1410 is paired with a system of recording and communicating secure transactional stamps for use in a producing a secure report admissible under the Federal Rules of Evidence. In a first example, the personal identification device stores, transmits, and/or receives true and accurate data in a secure manner usable with an established system, such as a legal system or a medical system. In a second example, the personal identification device, such as the bracelet 300 worn by the individual 312, identifies the particular individual and warrants the localized presence of the particular individual to an outside system, such as to the company 120, the matching system 130, to a kiosk, to an internet portal, and/or to a personal communication device, such as a smart phone, tablet, or phablet. Communication from a personal information communication device is optionally performed using a radio-frequency tag, such as a tag communicating using at least one frequency in the range of one kilo-hertz to one giga-hertz. Optionally, any information associated with the personal identification device and/or the peripheral device is maintained in a secure format warranting true information, usable in a legal setting. Optionally, time stamps of any of the communications with the auxiliary device are recorded in a secure transactional stamp. In still another example, the personal identification device is used in communication of a secure transactional stamp to: (1) a controller of a vehicle ignition system; (2) a police authority; (3) a police authority system; (4) a supervisor; (5) a parole officer; and/or (6) a law enforcement network.

Generally, any of the data recorded in any of the logs is verifiable in terms of time with a time stamp, information in terms of a sensor, data in terms of internal restricted access computer code, and data changes in terms of name of the personnel, and/or optionally via use of a history log in a manner admissible under the Federal Rules of Evidence.

### Personal Monitor

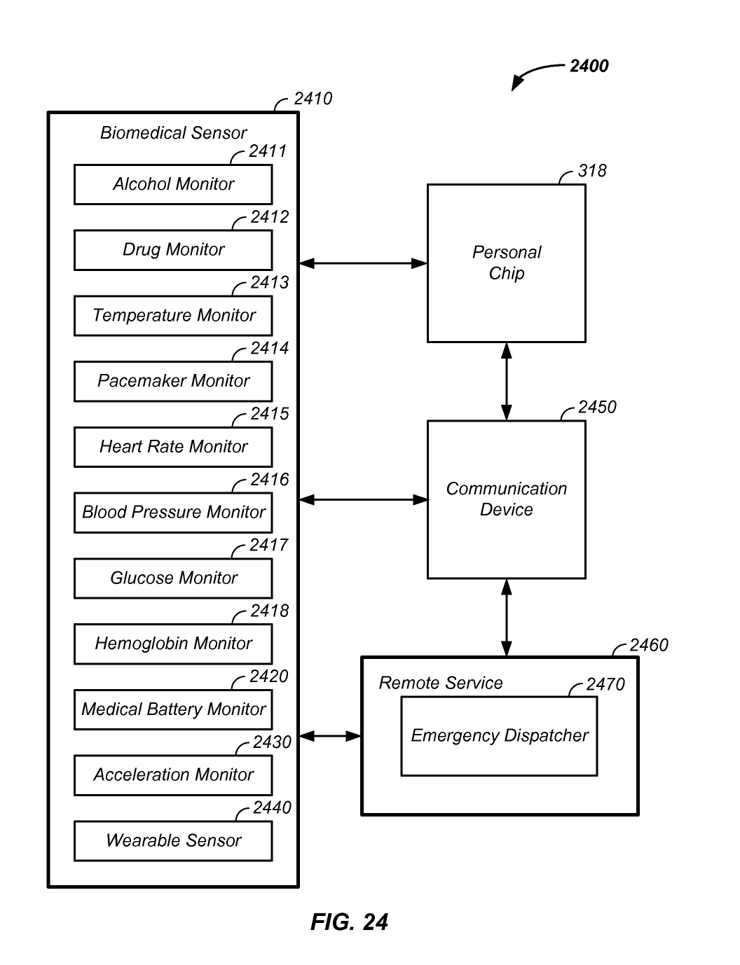

The general profile system 110 and personal profile system 300, described, supra, describes using the matching system 130 to match the individual 30 to an external system 740, such as a product 40, event 50, group 60, location 70, and/or business 120. Referring now to FIG. 24, optionally, the external system 740 comprises a remote service 2460. Several non-limiting examples of remote services include: an emergency dispatcher 2470, a fire department, a medical system, a medical professional, the police, a parole officer, a government authority, a warden, and/or an attorney.

Still referring to FIG. 24, an example is provided where the personal profile system 300 is linked to a biomedical device, a biomedical sensor 2410, and/or a personal monitor. For instance, the biomedical sensor 2410 is used to read a body parameter of the individual 312 using a peripheral device, such as a wearable personal device, an alcohol monitor 2411, a drug monitor 2412, a temperature monitor 2413, a pacemaker monitor 2414, a heart rate monitor 2415, a blood pressure monitor 2416, a pH meter, a hydration monitor, a glucose concentration monitor 2417, a hemoglobin monitor 2418, a medical battery monitor 2420, an acceleration monitor 2430, and/or a wearable sensor 2440. The biomedical sensor 2410 and/or any of the monitors is optionally used to monitor state of the individual 30. For example, the acceleration monitor 2430 optionally monitors sudden stops, indicative of an accident or fall, or monitors shaking of the individual, indicative of a seizure or drunkenness. Output and/or analysis of the biomedical sensor 2410 is optionally output directly and/or indirectly to: (1) the interface system 1400, (2) the external system 740, (3) the personal chip 318, (4) a communication device 2450, such as the personal identification system 1410, smart phone 1500, or personal communication device, and/or (5) the remote service 2460. In the event of an abnormality, the abnormality and location of the individual 30 is preferably automatically relayed to an appropriate external emergency system. The personal identification system 1410 is optionally used as a part of the process of relaying personal data and/or emergency data to the remote service 2470 and/or emergency service. The biomedical sensor 2410 is optionally carried and/or worn by the individual 30.

### Personal Web

In yet still another embodiment, a personal resource system 2500 is described. In the personal resource system 2500, elements of the world wide web 2520 and/or any element of the cloud 2530 related to the personal profile system 300 are extracted using a personal web extraction system 2510 and stored on a device accessible to the individual 30, such as a personal computing device 2540. The personal computing device 2540 is optionally a personal web system 2542 and/or a personal cloud 2544. Generally, the individual 30 has a limited number of interests relative to information held in the world wide web 2520 and/or the cloud 2530. Hence, for most purposes a subset of the world wide web 2520, such as the personal web system 2542, and/or a subset of the cloud 2530, such as the personal could 2544, suffices to answer queries of the individual 30. The personal web extractor system 2510 uses the personal profile system 300 to continually, intermittently, and/or periodically update the personal computing device 2540 of the individual 30 with elements of the world wide web 2520 and/or cloud 2530 related to and/or matching, such as with the matching system, elements of the personal profile system, such as held within the personal profile information 370 and/or personal chip 318.

In yet another embodiment, a personal identification device, such as the bracelet or an embedded microchip used to identify the person, is in communication with an auxiliary device and/or a remote system.

Still yet another embodiment includes any combination and/or permutation of any of the elements of any of the embodiments described herein.

Herein, a set of fixed numbers, such as 1, 2, 3, 4, 5, 10, or 20 optionally means at least any number in the set of fixed number and/or less than any number in the set of fixed numbers.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although the invention has been described herein with reference to certain preferred embodiments, one skilled in the art will readily appreciate that other applications may be substituted for those set forth herein without departing from the spirit and scope of the present invention.

1. A system for matching an external system with an individual, comprising the steps of:
receiving a communication of personal profile information from a wearable portable information communication device proximate the individual;
matching the personal profile information with at least one of a providable good, a providable service, and a providable event provided by the external system to determine a match;
within ten minutes, notifying the individual of the match.

2. The system of claim 1, further comprising the step of:
the individual wearing said portable information communication device while sending the communication to the external system, the communication comprising a broadcast communication, said broadcast comprising a broadcast range of less than ten thousand meters.

3. The system of claim 2, further comprising the step of:
using a personal communication device to relay the personal profile information from said portable information communication device worn by the individual to the external system.

4. The system of claim 3, said personal communication device comprising at least one of:
a phone;
a tablet; and
a phablet.

5. The system of claim 2, said step of receiving further comprising the step of:
authenticating the communication through use of a digital certificate admissible under the Federal Rules of Evidence.

6. The system of claim 2, said wearable portable information communication device comprising at least one of:
an earring;
a ring;
an object held through a piercing through tissue;
a bracelet;
a watch; and
a necklace.

7. The system of claim 6, said step of receiving a communication further comprising the step of:
obtaining from the individual at least one of:
a risk tolerance of the individual; and
a psychological profile of the individual.

8. The system of claim 6, said step of receiving a communication further comprising the step of:
obtaining, using wireless communication from the portable information communication device of the individual, at least one of:
a desired specific good;
a desired specific service; and
a desired specific event.

9. The system of claim 6, said step of receiving a communication further comprising the step of:
obtaining directly from the portable information communication device of the individual at least one of:
a set of parameters of a desired good;
a set of parameters of a desired service; and
a set of parameters of a desired event.

10. The system of claim 6, said step of receiving communication further comprising the step of:
acquiring basic information from the individual comprising all of:
core data of the individual comprising at least one: of an age, a gender, and an address of the individual; and
consumer data of the individual comprising at least one of: a transaction history and a website visitation history of the individual; and
acquiring detailed information from the individual comprising at least one of:
psychological profile information about the individual;
interpersonal relationship information about the individual; and
a personal preference of the individual.

11. The system of claim 6, said step of receiving communication further comprising the step of:
acquiring with permission of the individual at least one of:
an education level of the individual;
an income level of the individual; and
a travel history of the individual.

12. The system of claim 6, said step of receiving communication further comprising the step of:
acquiring, with permission of the individual, a criminal legal record of the individual.

13. The system of claim 6, said step of receiving communication further comprising the step of:
acquiring with permission of the individual an affiliation of the individual with a group, the group comprising one hundred to ten thousand members.

14. The system of claim 6, said step of matching further comprising the step of:
using a classifier to classify the individual into at least one of:
a group; and
a cluster.

15. The system of claim 6, said step of matching further comprising the step of:
determining, using the provided personal profile information provided by the individual, a discrete mathematical representation of the individual.

16. The system of claim 15, said discrete mathematical representation of the individual comprising at least one of:
a score; and
a weight.

17. The system of claim 15, said step of using a classifier further comprising use of at least one of:
a soft-model;
a neural network; and
a multivariate model.

18. The system of claim 6, said step of matching further comprising the step of:
determining, using the provided personal profile information provided by the individual, a probabilistic mathematical representation of the individual.

19. The system of claim 18, said step of determining using at least one of:
Bayesian statistics; and
a probabilistic analysis.

20. The system of claim 2, said step of notifying further comprising the step of:
said portable information communication device visually displaying an advertisement to the individual on a screen.

21. The system of claim 1, wherein said step of notifying further comprises the step of:
providing an offer to the individual using a digital certificate admissible under the Federal Rules of Evidence.

22. The system of claim 1, wherein said step of notifying further comprises the step of:
sending an individualcast to the individual, said individualcast comprising an advertisement based on the received communication sent to a current location of the individual outside of a home of the individual, said location provided in said step of receiving.

23. The system of claim 22, further comprising the step of:
limiting range of the individualcast, in said step of sending, to a termination point less than one mile from a position of the individual at time of said step of receiving.

24. The system of claim 22, further comprising the step of:
using global positioning system information received from the portable information communication device, with permission of the individual, in generation of the advertisement.

25. The system of claim 2, wherein said step of notifying the individual of the match further comprises the step of:
communicating the match to the individual through use of at least one of:
a phone;
a tablet; and
a phablet.

26. The system of claim 2, wherein said step of notifying the individual of the match further comprises the step of:
communicating the match to the personal communication device worn by the individual.

27. The system of claim 26, further comprising the step of generating a microsite using information related to the match and still further comprising the step of at least one of:
providing the microsite to the individual; and
providing a link to the microsite to the individual; and
providing data from the microsite to the individual.

28. The system of claim 1, said wearable portable information communication device comprising a bracelet.

29. The system of claim 28, further comprising the step of:
using said bracelet in at least one of:
rewarding points to the individual;
tracking achievements of the individual; and
redeeming multiple accomplishments of the individual.

30. The system of claim 28, further comprising the step of:
using said bracelet in tracking data of a chemical test of the individual.

31. An apparatus for matching an external system with an individual, comprising:
a receiver configured to receive a communication of personal profile information from a portable information communication device worn by the individual;
a data processing unit, configured to receive the personal profile information, said data processing unit used to match the personal profile information with at least one of a providable good, a providable service, and a providable event provided by the external system to determine a match;
an offer system configured to, within ten minutes, notify the individual of the match using a digital certificate admissible under the Federal Rules of Evidence.

32. A system for a business communicating with an individual, comprising the steps of:
receiving a broadcast using a personal information communication device of an individual, the broadcast containing a set of personal preferences;
creating a match by determining if said set of personal preferences matches at least one of:
a good of the business;
a service of the business; and
an event of the business; and
based on the match, sending, via an individualcast, the individual at least one of:
a link to a microsite, the microsite related to the match;
microsite data related to the match;
an offer;
information.
